(19) United States
(12) Patent Application Publication
(10) Pub. No.: US 2002/0129374 A1
(43) Pub. Date: Sep. 12, 2002

(54) COMPRESSED DIGITAL-DATA SEAMLESS VIDEO SWITCHING SYSTEM

(76) Inventors: MICHAEL J. FREEMAN, KINGS POINT, NY (US); KEVIN M. LIGA, PORT CHESTER, NY (US); FRANK P. DEO, KENDALL PARK, NJ (US)

Correspondence Address: DORSEY & WHITNEY, LLP, SUITE 4700, 370 SEVENTEENTH STREET, DENVER, CO, 80202-5647, US

(21) Appl. No.: 09/335,372

(22) Filed: Jun. 17, 1999

Related U.S. Application Data
(63) Continuation-in-part of application No. 09/154,069, filed on Sep. 16, 1998.
Application No. 09/154,069 is a continuation-in-part of application No. 08/887,314, filed on Jul. 3, 1997.
Application No. 08/887,314 is a continuation of application No. 08/443,607, filed on May 18, 1995.
Application No. 08/443,607 is a continuation-in-part of application No. 08/166,608, filed on Dec. 13, 1993, now abandoned.
Application No. 08/166,608 is a continuation of application No. 07/797,298, filed on Nov. 25, 1991, now abandoned.

(51) Int. Cl. H04N 7/173

(52) U.S. Cl. 725/91

(57) ABSTRACT

An interactive television system is disclosed which utilizes a various distribution networks for simultaneously providing a plurality of viewers with an interactive television program comprising a plurality of signals related in time and content. Video signals are transmitted in a digital format, more than one signal being multiplexed onto a data stream on a single channel. The video signals may be compressed for efficiency. A receiver, in conjunction with a signal selector, selects a particular channel for playback, then selects a particular video signal from the data stream, and decompresses the video signal for playback. Seamless switching between video signals on different channels is provided, as well as seamless switching between video signals that have been multiplexed on the same channel. An alternative embodiment is disclosed wherein the various signals which comprise the interactive program are switched at the head end rather than at the receiver. The multiple choice control unit selects a desired signal by relaying the multiple choice selections of the user through a relay box back to a remotely located switching station. The switching station routes the correct video signal down the appropriate TV channel for the particular user.

### CROSS-REFERENCE TO RELATED APPLICATIONS

This application is a continuation-in-part of application Ser. No. 09/154,069, filed Sep. 16, 1998, which is a continuation-in-part of application Ser. No. 08/887,314, filed Jul. 3, 1997, which is a continuation of application Ser. No. 08/443,607, filed May 18, 1995, now U.S. Pat. No. 5,724,091, which is a continuation-in-part of application Ser. No. 08/166,608, filed Dec. 13, 1993, abandoned, which is a continuation of application Ser. No. 07/797,298, filed Nov. 25, 1991, abandoned.

### BACKGROUND OF THE INVENTION

1. Field of the Invention

The present invention relates generally to interactive response systems, and more particularly to an interactive television system which provides interactive programming using compressed, digital data having more than one video signal on a broadcast channel, or a multiplexed signal within a digital format, or both.

The invention also relates to seamlessly switching between video signals while viewing a first video signal, even though the video signal switched to may be on a different broadcast channel, or on the same channel multiplexed with, the currently viewed video signal.

2. Description of the Prior Art

Interactive systems are well known in the art. By synchronizing parallel tracks of an information storage media, and relating the content of the various tracks, it was found that interactive activity could be simulated. For example, commonly owned Freeman, U.S. Pat. No. 3,947,972 discloses the use of a time synchronized multi-track audio tape to store educational conversations. One track is employed to relay educational interrogatories to a user, and the remainder of the tracks, selectable by a switching mechanism, are used to convey responsive messages.

These systems progressed to interactive television, wherein multiple broadcast or cable channels were switched in response to user selections to provide interactive operation. Commonly owned Freeman, U.S. Pat. No. 4,847,700 discloses an interactive television system wherein a common video signal is synched to a plurality of audio channels to provide content related to user selectable responses.

Commonly owned Freeman, U.S. Pat. No. 4,264,925 discloses the use of a conventional cable television system to develop an interactive system. Standard television channels with time synchronized content are broadcast to a plurality of users. Each user switches between channels responsive to interrogatories to provide interactivity.

These systems have been tailored to include memory functions so that the system can be more interactive, individually responsive, and so that customized messages may be given to the various categories of users responsive to informational queries. Freeman, U.S. Pat. No. 4,602,279 discloses the use of a memory to store demographic profiles of television viewers. This information is stored to be recalled later for providing target specific advertising, for example. Prior art interactive television systems were generally concerned with providing one signal (i.e. one video signal) per channel, whether the channel is on cable television, broadcast television, or a VCR. Because cable and broadcast television channel capacity is becoming limited as more and more cable channels are being utilized for conventional programming, and interactive systems of the type described require multiple channels, it is desirable to reduce the channel capacity required for such systems while still providing at least the same level of interactivity.

U.S. Pat. No. 5,724,091 disclosed and claimed seamlessly switching between video signals while viewing a first video signal, even though the video signal switched to may be on a different broadcast channel, or on the same channel multiplexed with, the currently viewed video signal. What is needed, however, is a less complex method and system for seamlessly switching between compressed digital video signals in a low cost digital set top environment.

### SUMMARY OF THE INVENTION

The present invention is a digital television system which utilizes digital video signals to provide customized viewing responsive to user selections. A standard cable or direct broadcast satellite television distribution network is preferably utilized for transmitting interactive and other programming to users. The present invention allows a plurality of viewers to be simultaneously provided with a plurality of different digitally compressed program signals. Further, interactive programs comprise a plurality of video signals.

The video signals are converted into digital format for transmission. In a digital format, it is possible to transmit more than one video signal per cable television channel. Further, it is possible to transmit video signals via conventional telephone lines. If desired, the various digital video signals may be compressed before transmission. Compression allows an even larger number of video signals to be transmitted over a channel of the transmission media. Preferably, the compression scheme used is one of the MPEG standard compression schemes, including MPEG2, MPEG4 and MPEG7. The video signals are fed into a digital data and video format, preferably in the MPEG format.

As part of the digital signal transmission, some of the signals are interactive and individualized programming. Such enhanced content is created by utilizing conventional video production techniques and by providing a multiplicity of video, audio, graphics and data in any combination thereof. The multiple video and audio information is time synchronized and, in most instances, preferably related in content. The subsequent interactions at the remote sites are controlled by the end use and producer, via the insertion of data codes representing a scripting language. These codes are preferably integrated and sent with the interactive video and audio signals and may be inserted either at a program control center or cable headend.

An multiplexer combines the various digital signals into a reduced number of transmission data streams for transmission. The various NTSC television channels may be allocated in a predetermined fashion to maximize the number of simultaneously transmittable signals. The multiplexer in conjunction with the television transmission system multiplexes the desired data streams onto the desired channels, and transmits these signals over the NTSC channels. The number of video signals which may be multiplexed onto a data stream on a single transmission channel will vary depending on the video signals to be transmitted. The television channels containing a data stream of multiplexed video signals may be transmitted over a standard cable television distribution network, or direct broadcast satellite transmission system.

After encoding, compression, multiplexing and modulation, the program signals and interactive program signals are distributed by a transmission means including, but not limited to, satellite, cable television, fiber optics, public switched telephone network, terrestrial broadcast, closed circuit, etc., where the modulation technique is defined by the means of transport. Additionally, the distributed content may include a signal conversion or retransmission prior to receipt by the end users.

The programs are received at an end user's location and connected to the appropriate reception device. Receptions devices, for example, may include, but are not limited to, cable television receivers/converters, satellite receivers, terrestrial broadcast receivers, personal computers, etc. The receiver receives one or more television channels, some or all containing a multiplexed data stream of video signals or non-multiplexed digital video signals, and in conjunction with a signal selector, selects a particular data channel/data stream for playback, then selects a particular video signal from the data stream's multiplexed signal, and finally expands the video signal, if necessary, for playback to a television monitor.

The signal selector may comprise a controller and software, for example, in a digital set top box. The controller and software in a digital set top box operate to control the receiver and signal selector to select a particular digital video signal.

A user inputs responses preferably via a standard remote device. The user may be simply changing from one digital channel to another or providing responses to an interactive program. In the interactive program embodiment, the user selectably responds to information displays or interrogatory messages and the signal selector selects a particular multiplexed video signal and de-multiplexes, expands and displays the selected video signal. Alternatively, the signal selector may select a video signal based on personal profile information stored in memory.

If more signals are needed for an interactive program than were mappable to a data stream on a single channel, the signal selector in conjunction with the receiver is programmed to switch between the various video signals within a multiplexed data stream as well as between data streams among the various broadcast channels to provide the necessary level of interactivity.

The various information segments in the various video signals preferably relate in real-time and content so that an interactive conversation can occur as the video signal is played back and the user responds to the various interrogatories on the video signals. The use of multiple signals per channel may be used for many types of interactive programs, including those disclosed in the previously mentioned U.S. patents, for example, field synchronized multiple camera angles from a sporting event, or an interactive game show. However, the present invention also covers the use of various video signals not related in real-time and content.

In a two-way embodiment, the various signals which comprise the interactive program may be switched at the head end rather than at the receiver. This embodiment may be used in a cable television system, a direct broadcast satellite system, a conventional telephone system modified to receive digital video signals, or any other appropriate transmission system capable of sending digital video signals. The multiple choice control unit, rather than the hand-held multiple choice controller, selects a desired video signal by relaying the multiple choice selections of the user through a relay box back to a remotely located switching station, preferably the cable television source. The multiple choice selections may be relayed to the switching station in any conventional means, such as two-way cable television, telephone, or FM transmission. If the interactive programming is being transmitted over a telephone line, the multiple choice selections may be relayed back over the same telephone line. The switching station receives the multiple choice selection of the user and routes the correct signal down the appropriate cable channel, telephone line, or other transmission media for the particular user. In such an arrangement, only a single link is required between the subscriber or receiver and the head end so that the one channel link can be used to receive a plurality of different channel selections dependent on the interactive choice relayed from the receiver to the video switch at the head end.

If desired, the two-way link may be used for other purposes, such as to transmit user demographic data back to the programming source for commercial reasons, or to allow an interactive game show player to win prizes, for example.

Once a signal is demodulated, the digital data stream is demultiplexed into its constituent elements such as video, audio graphics and data. The demultiplexed digital data stream is directed to the appropriate decode devices, i.e., video to video decoder, audio to audio decoder, graphics to display driver and control data to applications software.

In the interactive program embodiments, the application software reads the data and processes the scripting language. Further, the interactive application software processes input from the end user. Based upon a combination of inputs, it then decides upon the appropriate action. The viewing experience is then enhanced, based upon the individualization of the content by switching among the video, audio, graphical and data elements.

The system of the present invention allows improved performance during switching, making the channel switches transparent. Virtual channel applications for enhanced programming and addressable advertising will need to enable frequent switching among multiple MPEG video streams. When a channel change is required by a user response to an interactive interlude, a slight imperceptible delay is programmed to allow the expansion algorithm an opportunity to adjust to the rapid change from one video signal to another.

During the delay, previously obtained video information is displayed while the interactive system locates, receives, demultiplexes, decompresses, decodes, and processes the new video signal. This allows the interactive system to switch to the new video signal without flicker or distortion appearing on the TV screen, i.e., a seamless switch.

Disclosed are different methods to achieve this seamless switching. One involves an analog video frame buffer. Another uses two tuners. Other alternatives include: (a) using two digital video buffers; (b) using a large memory; (c) using a large buffer in an embodiment similar to that of (b); and (d) switching at the cable headend.

The present invention includes a preferred improved method and system for seamless switching between MPEG compressed digital signals in a digital set top, HDTV or personal computer environment. While the MPEG standard discusses the use of splice points, such points are difficult to insert in video streams that come from different sources, which is the typical cable television environment. This is because streams that have been compressed at separate times may have different clocks and therefore different timing information. By making some modifications on the encode process for the virtual channel applications, novel enhancements can be made to splicing. Such enhancements of the present invention include locking the time bases of the multiple channel encoders, genlocking the video sources, time synchronizing the start of the encode process, and inserting splice points at the appropriate locations in the GOP. The present invention utilizing these constraints and others for various virtual channel applications has the significant advantage of requiring virtually no hardware changes to most conventional digital set top converters.

In another embodiment of the invention, live or pre-recorded programs are automatically converted to DVD at the time of production or in subsequent edit editions. In this manner, the live or pre-recorded programs can be converted to DVD for later playback. Once the program is converted to storage on one or more DVDs, the DVD can be played back at a central location (such as a cable headend) and the multiple audio, video, Html/web links, control codes and/or graphics signals stored thereon that comprise the program can be transmitted over any of the transmission means to any of the receiver stations disclosed herein. Alternatively, the DVDs with embedded programs could be sold by distributors to consumers for home use. Because the DVD would contain the ACTV control codes, any type of receiver station with the interactive embedded software described herein would be capable of local play back of the program off the DVD.

### BRIEF DESCRIPTION OF THE DRAWINGS

FIG. 1 is a block diagram of the Interactive Television System of the present invention.

FIG. 2 is a block diagram of the system of the present invention in a two-way transmission configuration.

FIG. 3 is a block diagram of one embodiment to achieve seamless switching between video signals.

FIG. 4 is a block diagram showing an alternative embodiment to achieve seamless switching between video signals.

FIG. 5 is a block diagram of an embodiment of a central programming location.

FIG. 6 is a block diagram showing video splice points and time gaps in the video programming streams.

FIG. 7 is block diagram of an alternative embodiment of a reception box.

FIG. 8 is a block diagram of alternative audio frames.

FIG. 9 is a block diagram of a TV broadcast station switcher.

FIG. 10 is a block diagram of an embodiment for Non-related Program Switching.

FIG. 11 is a block diagram of an embodiment for Switching within Multiple Event Programming.

FIG. 12 is a block diagram of an embodiment for Seamless Picture-in-Picture Program Switching.

FIG. 13 is a block diagram of an embodiment for Switching within Multiple Commerce/Shopping Programming.

FIG. 14 is a block diagram of an embodiment for Digital Program Insertion—Addressable Advertising.

FIG. 15 is a block diagram of an embodiment for Seamless Switching from a Group of Signals to Other Signals at a Server.

FIGS. 16A and 16B are block diagrams of an alternative Two-Tuner Embodiment.

FIG. 17 is a block diagram of an alternative Two-Tuner Embodiment.

### DESCRIPTION OF THE PREFERRED EMBODIMENT

The present invention is an interactive television system in which a plurality of viewers are simultaneously provided with a plurality of different program information message signals. A plurality of video signals 1 are provided. Video signals 1 may be, for example, various field and/or audio synchronized camera angles of a sporting event, or a game show having a content and host acting responsively to user selections. Alternatively, video signals 1 may be any video signals suitable for interactive conversation, such as those described in U.S. Pat. Nos. 4,847,700, 3,947,972, 4,602,279, 4,264,925, or 4,264,924, the contents of which are incorporated specifically herein by reference. Various types of time and content related video signals exist which are suitable for interactive operation.

In previous systems, these various signals would be transmitted to a receiver on separate broadcast or cable channels, each requiring a separate 6 MHZ NTSC channel. According to the present invention, video signals 1 are directed to analog-to-digital (“A/D”) convertors 2 which convert the various video signals into digital format for transmission. A/D convertors 2 may be of any conventional type for converting analog signals to digital format. An A/D convertor may not be needed for each video signal 1, but rather fewer convertors, or even a single convertor are capable of digitizing various video signals 1. Interactive video programs may also be delivered to a cable or other distribution network in pre-digitized and/or precompressed format.

Digital conversion results in very large amounts of data. It may therefore be desirable to reduce the amount of data to be sent, allowing more signals to be sent over a single transmission channel. For example, a single frame of digitized NTSC video represents over 350 Kbytes of data. Therefore, two hours of standard video is about 80 Gbytes. Since there are 30 frames/sec in such video, the data transfer rate is 22 Mbytes/sec. This large amount of data is preferably reduced by digital compression.

In order to reduce the data transfer requirements, the various digital video signals are preferably compressed before transmission. The video may be compressed by any conventional compression algorithm, the two most common types being “processor intensive” and “memory intensive.” The processor intensive approach performs compression by eliminating non-changing aspects of a picture from the processing in the frame-to-frame transfer of information, and through other manipulations of picture information involving mathematical computations that determine the degree to which a given motion in a picture is perceptible to the human eye. This approach depends on high-speed processing power at the transmission point.

The memory approach involves division of a picture frame into hundreds of minuscule blocks of pixels, where each block is given a code representing its set of colors and variations in luminance. The code, which is a much smaller increment of information than all the information that would describe a given block of the picture, is transmitted to the receiver. There, it calls up the identically coded block from a library of blocks stored in the memory of the receiver.

Thus, the bit stream represents a much smaller portion of the picture information in this approach. This system is generally limited by the variety of picture blocks which may be stored in the receiver, which relates directly to memory size and microprocessor power.

Examples of commonly known compression techniques which may be used with the invention are JPEG, MPEG1 and MPEG2.

Data Compressors 3 are provided to reduce the data for each video signal which must be transmitted. Data compressors 3 may be of any conventional type commonly known in the art for compressing video images, such as those previously described. Compression of the various video signals might be done with fewer data compressors 3 than one compressor per video signal. In a conventional analog NTSC system, by way of example, it is customary to transmit one video signal per 6 MHZ channel. By digitizing the video signal, it is possible to send a data stream containing more than one video signal in one channel. Compressing the digitized signals, allows even more video signals to be transmitted over a single transmission channel. The number of signals which may be sent over a single channel is generally related to, for example, a) the type of video being sent; b) the video compression scheme in use; c) the processor used and memory power; and d) the bandwidth of the transmission channel.

Compression techniques exploit the fact that in moving images there is very little change from frame-to-frame. Editing out the redundancies between frames and coding just the changes allows much higher compression rates. The type of video which normally contains a great deal of high-speed movement, such as occurs at live sporting events, will, therefore, have the lowest compression rates. Movies, on the other hand, which normally have a lower frame rate and less frame-to-frame change than a live sporting event will achieve higher compression rates. Currently, commonly known compression schemes have compression rates that vary from 2:1 to 10:1 for satellites, and 2:1 to 5:1 for cable television systems, depending on the degree of motion.

Once the various video signals 1 have been digitized and compressed, multiplexer 4 combines the various digital signals into a reduced number of transmission data streams for transmission. For example, if 68 NTSC channels are available, and each channel is capable of transmitting either 4 digitized, compressed slow moving video signals (e.g. movies) or 2 digitized, compressed, high-speed video signals (e.g. sports), then the various NTSC channels should be allocated in a predetermined fashion to maximize the number of simultaneously transmittable signals.

As an example, the broadcast frequency corresponding to a first NTSC channel may contain a data stream of separate digitally compressed non-interactive movies. On this frequency, the data stream would contain video signals representing a number of movies. However, the video signals, unlike those of an interactive program, are not related in time and content. The frequency corresponding to a second channel might contain a digital data stream of an interactive sports program, consisting of two multiplexed compressed high-speed video signals that are preferably related in time and content. The frequency corresponding to a third channel might contain a digital data stream of an interactive movie consisting of four multiplexed compressed video signals which are related in time and content. The frequency corresponding to a fourth channel might contain an analog NTSC signal relating to local programming. Therefore, using the invention, four NTSC channels could contain a channel of multiplexed movies, an interactive sports program, an interactive movie, and local programming.

Multiplexer 4 receives the incoming compressed, digitized video signals and in a predetermined conventional fashion, in conjunction with transmitter 5, multiplexes the desired video signal onto the desired channels, and transmits these signals over the NTSC channels. Certain NTSC channels may contain only one video or other signal, in analog or digital form.

As indicated earlier, the number of video signals which may be multiplexed onto a data stream on a single transmission channel will vary. Also, the number of channels which use data streams may vary. The transmission data streams are transmitted by transmitter 4 via transmission media 6 to a receiving station 7. The transmitter 4, media 6, and receiver 7 may be any conventional means for transmitting digital video signals including broadcast television, cable television, direct broadcast satellite, fiber optic, or any other transmission means. Alternatively, the invention may be self-contained in a stand-alone system, as explained below.

The transmission means may also be a telephone system transmitting a digital video data stream. Thus, a multiplexed data stream containing several broadcast channels or an interactive program with related video signals may be sent directly to a user over a single telephone line. The aforementioned digital transmission devices may include means for transmitting analog signals as well.

In one of the preferred embodiments, the digital transmission signal is transmitted using a cable television system. Receiver 7 receives various NTSC channels, some or all containing multiplexed or non-multiplexed digital video signals. Ordinarily, more than one channel will be transmitted by transmitter 5 and received by receiver 7 as in an ordinary cable television system. However, each of the different channels may have a data stream containing several digitized video signals thereon. Therefore, receiver 7 preferably operates in conjunction with signal selector 8 to select a particular NTSC channel for playback, then to select a particular video signal from the data stream's multiplexed signal, and finally to uncompress or expand the compressed video signal, if necessary for playback to monitor 10.

Multiple choice controller 9 operates to control receiver 7 and signal selector 8 to select a particular video signal for playback. In practice, a user need not know that multiple signals per channel are in use. If, for example, 68 channels with 4 signals-per-channel were in use, controller 9, in conjunction with receiver 7 and signal selector 8 might be programmed to represent these channels to the user as channels 12-72. Monitor 10 may be, for example, a conventional television. Signal selector 8 preferably includes a conventional de-multiplexer for selecting a particular video signal from the data stream on the channel currently being received by receiver 7. Signal selector 8 further includes the necessary un-compression or expansion apparatus corresponding with the compression scheme in use by compressors 3.

In practice, an interactive sporting event program might be transmitted on a 6 cable television signal using a compression-multiplexing scheme which allows two sports video signals (A and B, for example) to be transmitted over a single NTSC channel (channel 34, for example). It might be desired to have four video signals (A-D, for example) for the particular interactive sporting event. A first video signal (signal A) may contain the standard broadcast signal of the game; the second video signal (signal B) may contain a close-up view of the game action; a third video signal (signal C) may contain a continuously updated replay of game highlights; the fourth video signal (signal D) may contain statistical information. These four video signals (A-D) may, for example, be multiplexed as follows: video signals A and B multiplexed onto a data stream transmitted on cable channel 34; video signals C and D multiplexed onto data stream transmitted on cable channel 35. Alternatively, all four video signals (A-D) could be multiplexed into one data stream carried on one frequency channel. These four signals may, however, be mapped by controller 9, or signal selector 8, to play as separate channel displays for the user which, when the viewer makes choices on the multiple choice controller, a seamless switch occurs therebetween. Each video signal of this interactive program may include a label which reads, for example, “Full-Screen Action—Press A: Close-up Action—Press B: Replay—Press C: Statistics—Press D.”

As shown, if more signals were needed for an interactive program than were mappable to a data stream on a single channel, signal selector 8 in conjunction with receiver 7 may be programmed to switch between the various video signals 1 as well as the various broadcast channels to provide the necessary level of interactivity. However, preferably all the various video signals associated with a particular interactive program are multiplexed onto a single channel.

Additionally, the signal selector 8 may store information relating to current and previous user responses. For example, the personal profile of the viewer or previous response patterns of the viewer could be stored in memory. This information may be used in conjunction with commands transmitted within the video signals, as discussed in U.S. Pat. No. 4,6502,279, incorporated herein by reference. The stored personal profile information and received commands may be used to switch interactively between data streams and video signals without any additional response from the user.

The multiplexed interactive program may be transmitted over a single telephone line, if desired. In this embodiment, multiple choice controller 9 is programmed to switch between the various video signals on the single telephone line. If additional channels were desired, a two-way configuration is used as described below.

The system of the present invention may be utilized in an educational embodiment. In this embodiment, information is stored on each data stream in a plurality of reproducible information segments, each of which comprises a complete message reproducible by the receiver directly in response to the selection of the video signal by signal selector 8 responsive to a user selection on multiple choice controller 9. Each of the information segments in the various data streams contain interrogatory messages with associated multiple choice responses, responsive messages, informational messages, or combinations thereof.

The various information segments in the various data streams preferably relate in real-time and content so that an interactive conversation may occur as the video signals are displayed and the user responds to the various interrogatories contained in the video signals. As a user answers a particular interrogatory with a multiple choice response, the information in the video signal associated with the particular selection is displayed by the signal selector 7. The various interrogatories, responsive messages, and informational messages may generally be contained in any one, more than one or all of the various video signals.

The use of a data stream containing multiple video signals per broadcast channel may be used for many types of interactive programs, such as those disclosed in the previously mentioned U.S. patents. Other interactive programs may be developed which are within the scope of the present invention.

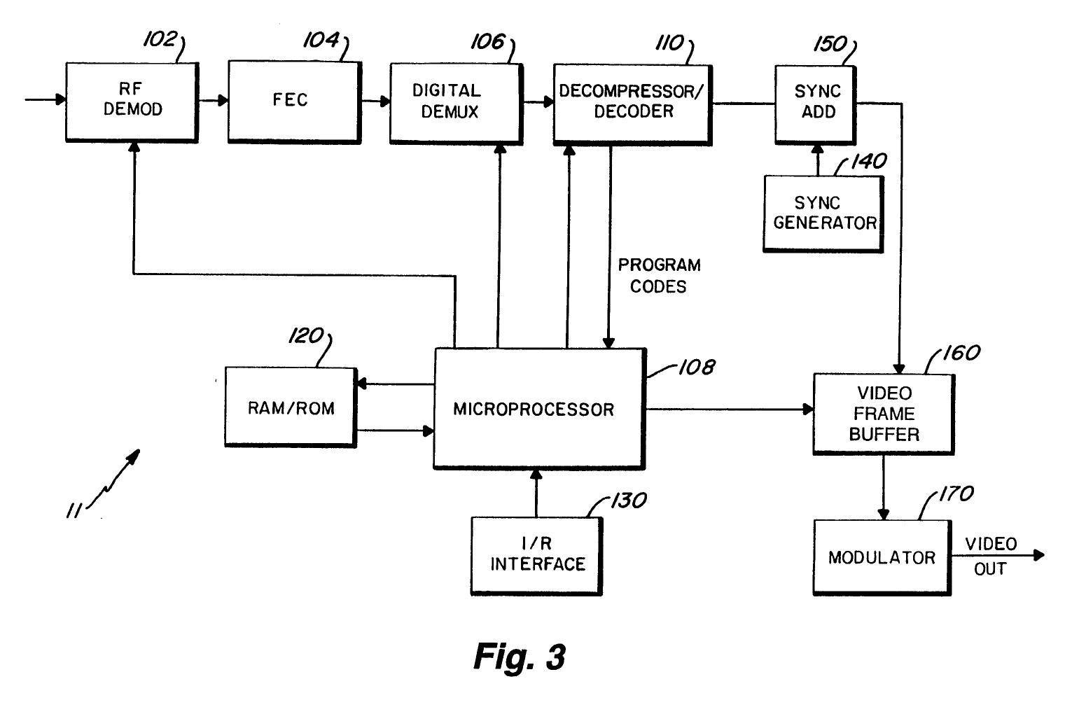

The present invention may also be utilized as a stand-alone system with no transmission means necessary. In this embodiment, the digitized video signals that make up an interactive program are stored in local storage means such as video tape, video disk, memory (e.g., RAM, ROM, EPROM, etc.) or in a computer. Preferably, the digital video signals are multiplexed onto a standard NTSC signal. The particular storage means may be connected to any of the interactive boxes disclosed in FIGS. 3-5, and described below. The interactive boxes would then be connected to a television set. Alternatively, the circuitry in FIGS. 3-5 below could be implemented on a board and inserted into a standard personal computer (PC). A separate microprocessor on the interactive board is not necessary for this configuration since the standard PC processor performs the functions of the processor 108 shown in FIGS. 3-5.

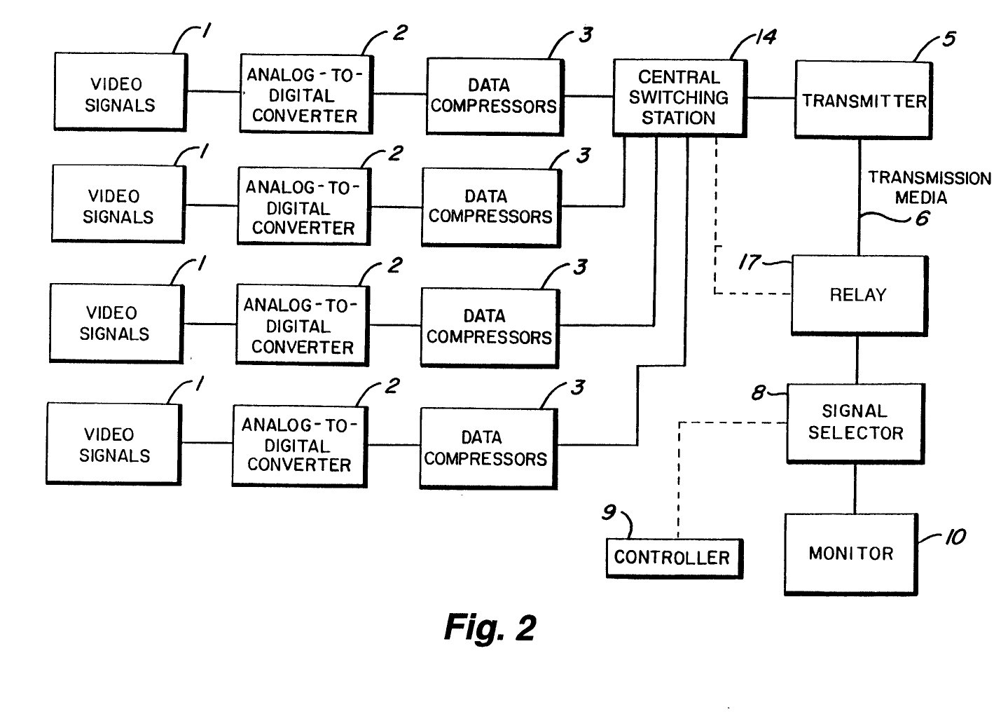

As shown in FIG. 2, the system of the present invention may be operated in a two-way configuration. In this mode, the various video signals 1 are processed as previously described, being digitized by A/D convertor 2 and compressed by video compressors 3. The signals are then routed to a central switching station 14. In this embodiment, the switching between the various video signals is accomplished at the head end rather than at the receiver. Multiple choice control unit 9 relays the multiple choice selections of the user through a relay box 17 back to the remotely located switching station 14. The multiple choice selections may be relayed by relay box 17 to the switching station by any conventional means, such as two-way cable television, telephone, or FM transmission. Switching station 14 receives the multiple choice selection of the user and routes the desired signal to transmitter 5 which conventionally transmits the desired video signal down the appropriate cable channel for the particular user. If desired, transmitter 5 may also transfer conventional programming on the cable television channels not being used for interactive programming. Alternatively, switching station 4 may include multiplexing equipment as previously described, and thus operate multiple interactive or noninteractive programs over a single television channel.

For example, if it were desired to implement the interactive football game program as previously described, a single NTSC cable channel may be allocated for the program. However, in this instance, the video signals would be present at the transmitting end. In response to a signal from wireless controller 9, a signal is sent by relay box 7 to the cable TV switching station which routes the desired video signal to the requesting viewer. Such a system requires very fast switching equipment, but can be implemented using digital imagery.

Alternatively, it may be desirable to transmit the interactive sporting event over a single telephone line. When the user enters a selection on controller 9, a signal is sent via the telephone line to the central switching station which routes the desired signal of the interactive program over the user's telephone line so that a single link handles both the interactive choice being made at the receiver and the transmission of that choice, out of a plurality of choices, from the head end where the actual switching takes place in response to the interactive selection made at the receiver.

The two-way link between the user and the switching station may be used for other purposes. For example, demographic data may be transferred from the user to the broadcast network for commercial purposes, such as targeted advertising, billing, sending a game show winner a winning number for pickup of a prize, or other commercial or non-commercial purposes.

As previously described, compression systems generally perform less efficiently when frame-to-frame content includes many changes in pixel content (e.g., during fast motion or scenery changes). The system of the present invention may be advantageously programmed to ease the processing burden on the uncompression program. When a key on the controller is depressed to select a desired signal, a slight imperceptible delay may be effectuated if desired. This delay allows the uncompression or expansion algorithm a short period of time to adjust to the rapid change from one video signal to another which ordinarily causes a degradation in the efficiency of the algorithm causing video glitches to appear on the screen display.

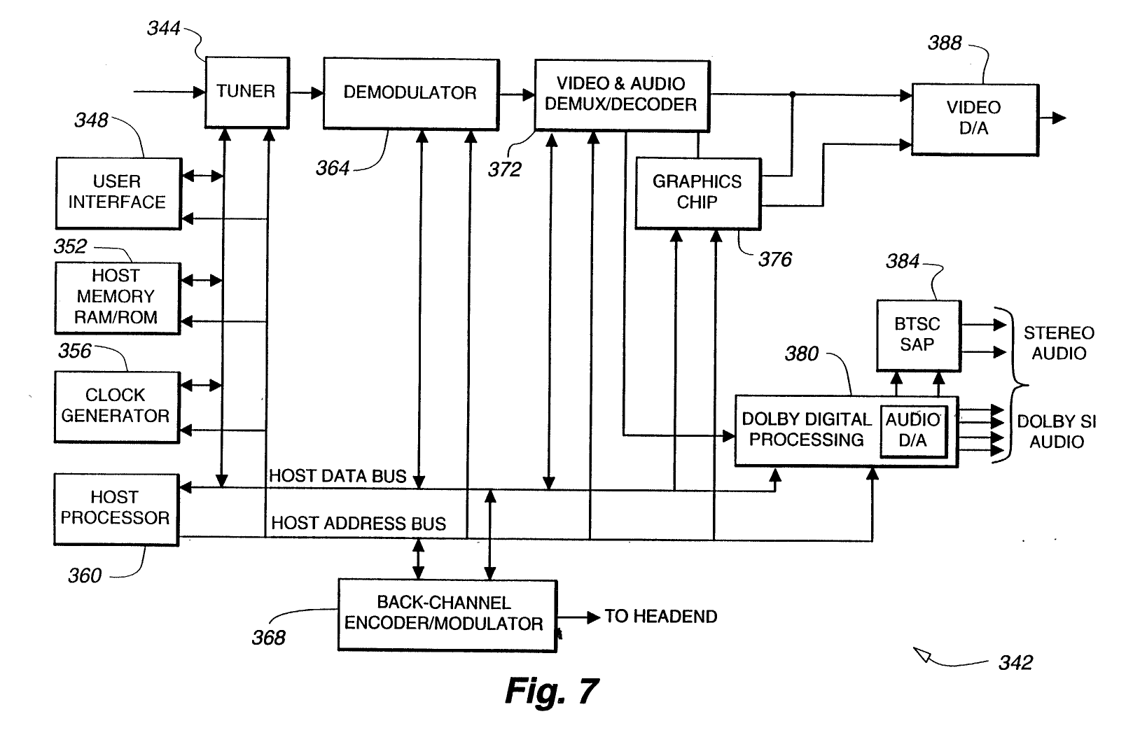

As shown in FIG. 7, a two way link (similar to FIG. 2) may also be used, employing virtual channels back to the user. In this embodiment, multiple video signals, preferably related in time and synchronous to each other, are present at a cable headend 300 on multiple channels A, B, . . . N of a video signal bus 250. The signals may be locally generated or received from a remote location (such as a sporting arena) by receivers 200, 202, 204, and 206. Alternatively, if the remotely received signals are digitally multiplexed onto one channel, a digital demultiplexer would replace receivers 200-206 and would demultiplex the signals and place each signal on a separate bus channel. The local or remote signals are synchronized by sync circuit 208. A number of remote control interactive switches 210, 212, 214, 216, and 218 are connected to video signal bus 250. The multiple channels on bus 250 are provided synchronously and simultaneously to the series of remote control interactive switches 210, 212, 214, 216, 218. These remote control interactive switches are dynamically allocated to users who request access to an interactive program. Each switch is connected to a frequency agile modulator 220, 222, 224, 226, 228 to assign the switch a virtual channel in order to connect a signal from bus 250 to a specific user at a remote site. Each switch is assigned to a single user so the number of switches present at the headend is the limiting factor to the number of users who can interact simultaneously. If it is assumed that only a portion of the users will interact simultaneously, an algorithm is used to determine the optimum number of remote switches necessary to assure an acceptable percentage of access.

After passing through the frequency agile modulators 220, 222, 224, 226, 228, the signals from video signal bus 250 progress through the cable (or broadcast TV) system 260. The signals may pass through RF feed 262 and amplifier 230. The user's set top box 232, 234, 236, containing a frequency agile demodulator, is tuned to the frequency of the associated frequency agile modulator 220, 222, 224, 226, 228. The decoded signal from the set top box 232, 234, 236 is displayed on television monitor 10.

When a user desires to interact, the user issues a command on the controller 9. The command is received by the set top box 232, 234, 236. A user request is sent back down the cable or other transmission system 260 to one of the remote switches 210, 212, 214, 216, 218. At the appropriate time, based on the user request and the algorithm for interactivity which accompanies the program, the remote switch makes a cut during a vertical blanking interval from one signal on bus 250 to another signal on bus 250. The result of this switch is modulated by one of the frequency agile modulators 220, 222, 224, 226, 228 and sent down the virtual channel to the user, who sees a seamless cut from one image to the other as a result of the interaction. The signal delivered to the user may be full bandwidth or compressed video. Likewise the video signal on the bus 250 delivering the simultaneous signal to the multiple remote switches 210, 212, 214, 216, 218 may be compressed video. This embodiment allows for a relatively low cost remote user box because the most costly switching equipment is located at the headend and each remote switch may be allocated to any user. Therefore, the cost is spread over the larger population of users.

As an example, it is assumed that the signal received by receiver 206 is placed on bus line 270 of the video signal bus 250 and is forwarded to set top box 236 and displayed on monitor 10. At some point the set top box 236 causes a user request to be generated. The user request is based on a current or past entry on controller 9 and/or information stored in set top box 236 (e.g., information stored could be previous user response information or personal profile information). The cable TV system 260 may amplify the user request at amplifier 230 while carrying the user request back to frequency agile modulator 226, which communicates the request to remote switch 216. During the vertical blanking interval, the remote switch 216 disconnects from old bus line 270 and switches to the appropriate line on the video signal bus 250, in this example line 280, based on the user request. This is shown by the dotted-line connection at 290. The signal from the new connection (received by receiver 204) is sent through the frequency agile modulator 226 on channel 47 and the cable TV system 260 to the user's set top box 236. The new signal is seamlessly displayed on television monitor 10, without any switching occurring at set top box 236.

As alternatives to the cable headend 300 and cable TV 260 of FIG. 7, a telephone central office and/or telephone lines may be used. This alternative would allow the set tops 232, 234, 236 to receive interactive programming from a telephone company or cable headend via telephonic communication.

FIGS. 3, 4, 7, 16 and 17 show preferred embodiments of the receiver 7 and signal selector 8 of the present invention to enable seamless flicker-free transparent switching between the digital video signals on the same channel or different channels. These embodiments may be connected to any transmission media or simply connected to the output of any stand-alone storage means for the digitized multiplexed interactive program. Preferably, the receiver 7 and signal selector 8 are both components of an interactive program box 11, which connects to a television or other display monitor. Alternatively, the required functionality of the RF receiver 7, signal selector 8 and monitor could all be combined in a standard personal computer by the addition of a few components to the personal computer. To provide this capability, only an RF demodulator board, digital demultiplexer, decompressor(s), frame buffer(s), and sync components need to be added to the personal computer. These items, and any other components, may be connected to the PC processor and storage elements as disclosed in FIGS. 3, 4, 7, 16 and 17. In this embodiment, the user makes selections via the computer keyboard.

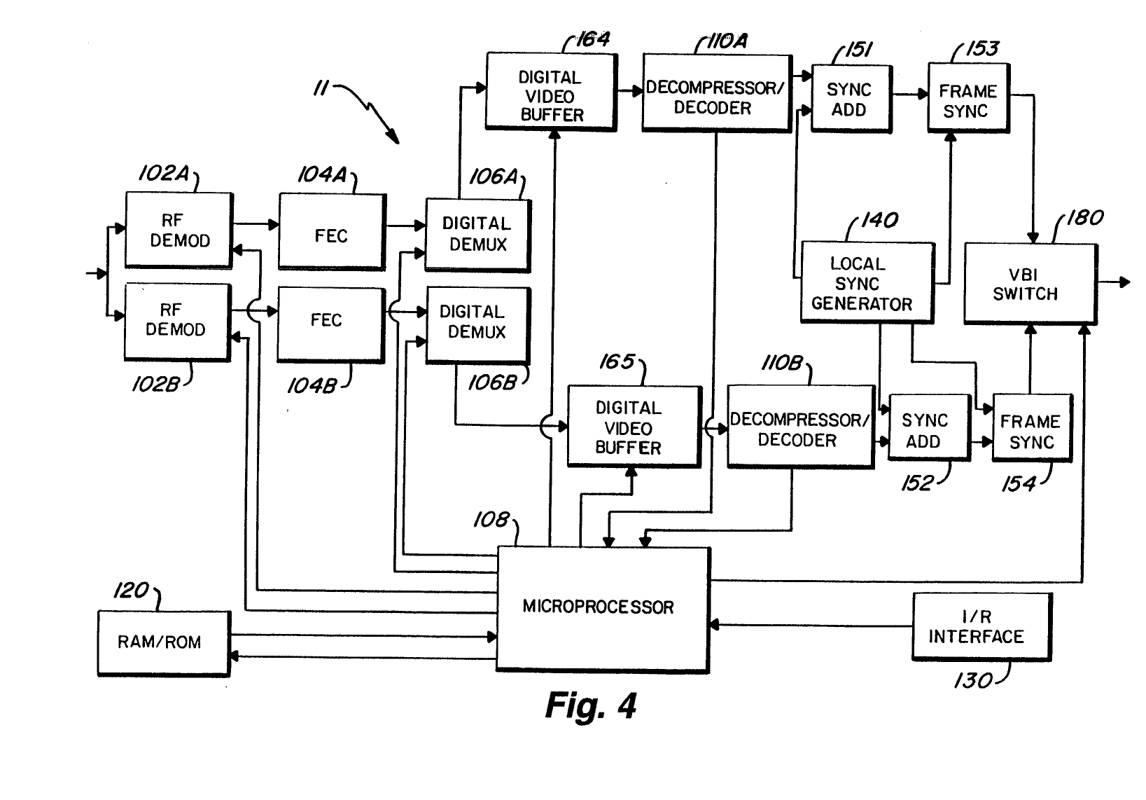

FIG. 3 shows an embodiment with a single analog frame buffer. FIG. 4 includes pairs of RF demodulators, error correctors, and demultiplexers and/or a pair of digital video buffers, as described below.

FIG. 3 shows an embodiment which allows for a seamless video switch between two or more separate digital video signals. As shown in FIG. 3, a microprocessor 108 is connected to RF demodulator 102 and digital demultiplexer 106. The microprocessor 108 directs demodulation and demultiplexing of the proper channel and data stream to obtain the correct video signal. The proper channel is determined either by examination of the user's input from user interface 130 and/or any other information or criteria (such as personal profile information) stored in RAM/ROM 120. For example, the RAM/ROM 120 could store commands provided within the video signals as discussed in U.S. Pat. No. 4,602,279, and incorporated herein by reference. The user interface 130 may be an infrared, wireless, or wired receiver that receives information from multiple choice control unit 9.

The RF demodulator 102 is part of the receiver 7, and demodulates data from the broadcast channel directed by the microprocessor 108. After the data stream is demodulated, it passes through a forward error correction circuit 104 into a digital demultiplexer 106. The demultiplexer 106 is controlled by microprocessor 108 to provide specific video, audio and data signal out of a number of video; audio and data signals located within the data stream and steer them to the appropriate device for use within the system. In order to seamless splice from one video stream to the other it is preferred to perform the switch in the digitally compressed domain thereby eliminating the need to decode two video audio and data streams at the same time.

When the compressed digital video is sent to the video decode function it is first stored in memory 160 until there is enough information buffered to ensure continuous playback of the video stream. Because of the compressed nature of the video information, a relatively small buffer 160 can hold a significant amount of video information (on the average of five to six frames). This means that there is a significant delay from the time the compressed video is received to the time it is decompressed and played out. Therefore, the preferred method for switching in the set top would be to select the new video on the way into the video buffer 160 while continuing to play out the old video to the monitor. Because the incoming stream has been created by producing syntactically correct MPEG segments that are sliceable, this can be achieved easily. By this method there is no need for additional hardware in the receiver. A video always appears to the viewer to be a single video stream with no repeated or dropped frames.

MPEG allows for the reconstruction of the video clock at the receiver 11 through use of a data field called the PCR (Program Clock Reference). This is necessary to ensure that the decoder can play out the decoded video at the same rate as it was input to avoid dropping or repeating frames. Additional embedded information in the MPEG stream includes the PTS (presentation time stamp) and DTS Display Time Stamp. These signals are used to maintain lip synchronization with the audio and also to inform the receiver when to present the video and audio to the display.

FIG. 4 shows an alternate, dual tuner embodiment for seamless switching between separate video signals. In this embodiment, the microprocessor 108 controls the selection of the RF channel that is demodulated by RF demodulators 102A, 102B. The demodulated data streams enter the forward error correctors 104A, 104B. At the output of the forward error correctors, the data streams are transmitted to the input of the digital demultiplexers 106A, 106B.

As with the RF demodulators 102A, 102B, the digital demultiplexers 106A, 106B are controlled by the microprocessor 108. This configuration allows the microprocessor 108 to independently select two different individual time-multiplexed video signals on different channels and data streams. If all the video signals of an interactive program were contained on a single channel or data stream, it would only be necessary to have a single RF demodulator, forward error corrector, and digital demultiplexer serially connected and feeding into the two digital video buffers.

Two data streams are provided from the digital demultiplexers 106A and 106B. The output of the demultiplexers contain a multiplicity of video, audio and data that can now be directed to the appropriate device under microprocessor 108 control. In this way it is no longer necessary to have all of the information contained in one RF channel. Instead the information can be found at different frequencies in the RF spectrum and we will still be able to splice among the streams. By placing a simply digital switch at the output of the two demultiplexers we can avoid duplicating the entire decode chain. It should be noted that this is only a cost saving approach and duplication of the rest of the chain would work as well.

A standard MPEG stream contains different types of encoded frames. There are I frames (Intracoded), P frames (Predicated) and B frames (Bi-directionally predicted). A standard MPEG structure is known as a GOP (group of pictures). GOP's usually start with I frames and can end with P or B frames. There is generally only one I frame per GOP, but many P and B frames. While it is not necessary to have any I frames, they are useful for many reasons.

GOP's that end with B frames are considered open. GOP's that end with P frames are considered closed. For the present invention, preferable code is closed GOP's to ensure that there are no motion vectors pointing to frames that are outside of the current GOP.

MPEG also reorders the video frames from their original display order during the encode process in order to code the video more efficiently. This reorder must be undone in the decoder in order for the video to present properly.

| | |
|---|---|
| Frame Order | 1 2 3 4 5 6 7 8 9 10 11 12 13 14 15 16 17 18 19 20 |
| Frame Type | I B B P B B P B B P I B B P B B P B B P |
| Typical | |
| Frame Reorder | 1 4 2 3 7 5 6 10 8 9 11 14 12 13 17 15 16 20 18 19 |
| Transmission | |
| Order | |
| Frame Type | I P B B P B B P B B I P B B P B B P B B |
| | GOP1 GOP2 |

Splices occur at the end of the B frame at the end of GOP1 prior to the I frame of GOP2. It is important to point out that with appropriate controls the encoder can code with variable GOP length and place splice frames accurately to achieve the desire interactive effect. If the content is unrelated then the encoder can splice at the end of every GOP allowing for a multiplicity of switching opportunities. Because the GOP ends on a P frame, a closed GOP is yielded.

Improved Seamless Switching in a Digital System

Any of the above-described reception unit embodiments can be used to handle the seamless switching of the present invention. In the preferred embodiment, however, seamless video switching at the reception units is enhanced through certain novel modifications to the encoding process.

As set forth above, seamless switching between digital video signals, whether representing independent television programs or different related signals within one interactive program, is critical to the viewing experience. Seamless switching is defined as video stream switching that does not produce visible artifacts. The effect of the encoding process is to simplify and enhance the seamless switching process.

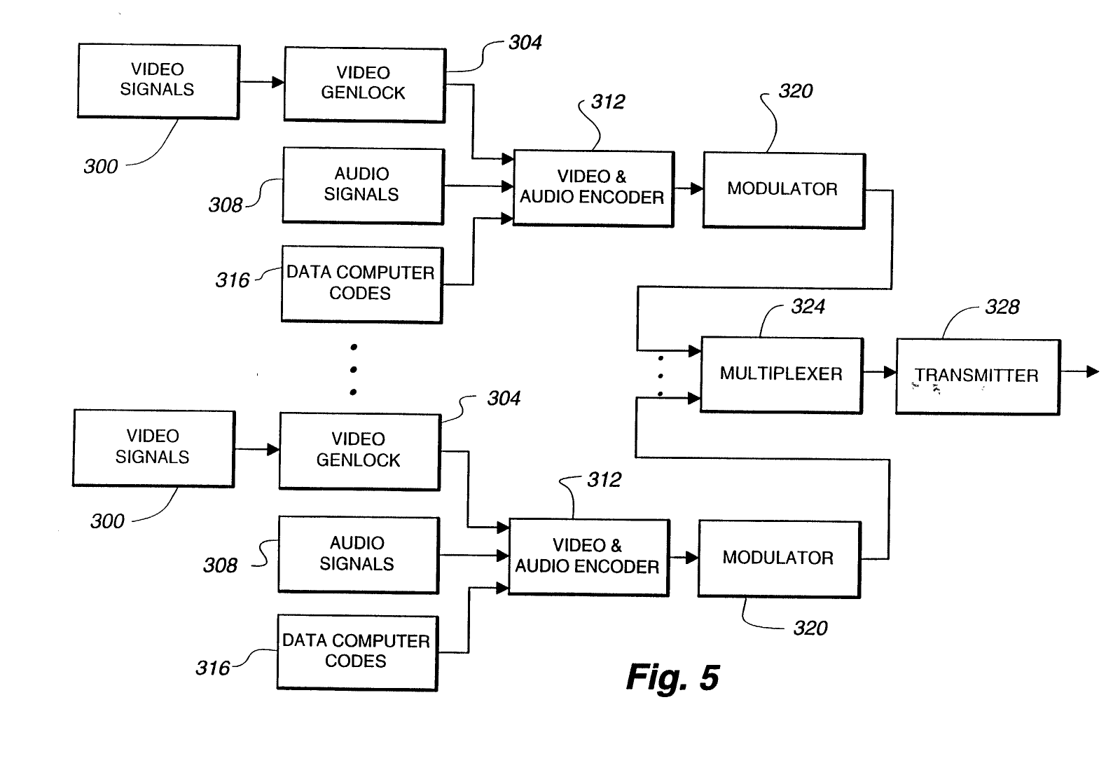

The encoding process is performed at a central location, the elements of which are shown in FIG. 5. As seen in FIG. 5, a plurality of video signals 300 are shown which could comprise live or prerecorded video streams. The origin of the video signals could be from cameras for live video, video servers, video tape decks, DVD, satellite feed, etc. The video signals can be in MPEG format, HDTV, PAL, etc. A plurality of audio signals 308 may originate from CD, tape, microphones, etc.

The data codes, shown emanating from the data code computer 316 in FIG. 5, are the interactive commands for interactive processing used by the set top converter, as discussed above. Preferably, the data codes are part of an interactive scripting language, such as the ACTV scripting language, originating in a coding computer 316. The data codes are also forwarded to the encoder 312. These data codes facilitate the multiple interactive programming options at the reception units. This embodiment requires a data channel for enabling a synchronous switch between a first video stream and a second video stream. This data channel comprises the codes which link together the different program elements and information segments on the different video signals.

Referring again to the video signals 300, the plurality of video signals 300 are genlocked in the video genlock device 304 and thus, time synchronized. The time synchronized video signals are directed into the video and audio encoder 312. In the preferred embodiment, compatible encoders 312 are required at the cable headend to work with the digital reception units at the remote sites. The interactive applications of the current invention are preferably facilitated by synchronizing the commands at the headend to a specific video frame and a specific audio frame. This level of synchronization is achievable within the syntax of the MPEG-2, 4 or 7 specifications.

In order to facilitate the seamless switch at the reception sites, the video encoders 312 are preferably time synchronized. This synchronized start is necessary to ensure that the splice points that have been placed in the video content occur at the correct frame number. While it is not necessary to obtain this level of accuracy for all program types, it is achievable in this manner. This provides content producers with the ability to plan video switch occurrences on a frame boundary within the resolution of the Group of Pictures (GOP). SMPTE time code or Vertical Time Code (VTC) information can be used to synchronize the encoders 312. Additionally, a splice can be placed accurately at any frame by utilizing the variable length GOP. Upon command from an external controlling device such as the ACTV command code computer 316, the encoder 312 can be directed to insert a splice at an frame number. Making encoder modifications at the headend ensures more effective seamless switching at the set top converters.

As shown in FIG. 5, multiple video signals 300, data codes 316 and audio signals 308 are input into the encoder 312. In the preferred embodiment, four video channels are input into the encoder 312. However, more or less video streams may be input based on the content that is to be delivered. In the current environment, practical limitations for the number of videos are based on picture quality. Ultimately, however, there will be no limit to the number of videos and audios that can be contained within a single channel. Further, all current limitations can be removed through the use of the alternate embodiment that describes a two tuner implementation.

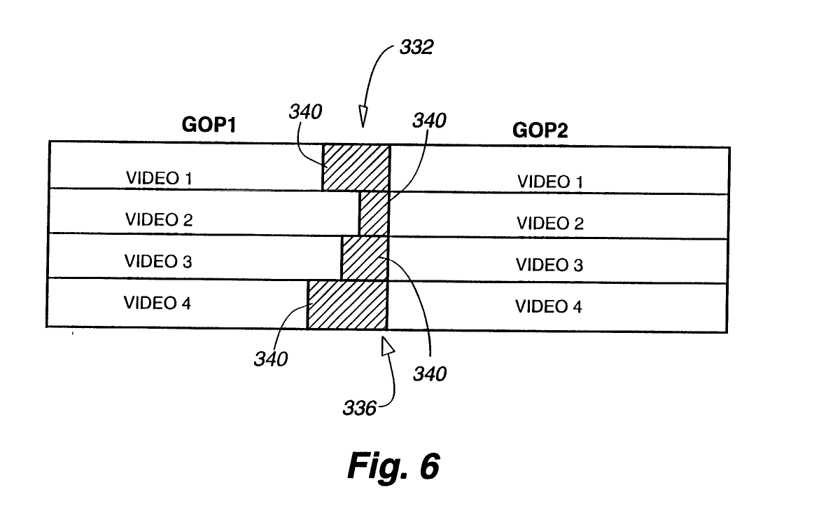

Preferably, the encoder 312 uses a standard MPEG-2 compression format. However, MPEG-4 and MPEG-7 as well as other compression formats, such as wavletts and fractles could be utilized for compression. These techniques are compatible with the existing ATSC and DVB standards for digital video systems. Certain modifications, however, are made to the MPEG stream in order to facilitate the preferred seamless switching at the set top box. These modifications to the encoding scheme are described below with reference to the video frame structure 332 shown in FIG. 6.

Switches at the remote reception sites will occur at the video splice point 336. Program switching is facilitated through the provision of splice points. The splice points are identified within the program stream via the adaptation field data. Program switching occurs at these points based on user inputs, personal profile information stored in memory at either the set top converter or the headend, and commands from the program source.

With respect to creation of the video splice point 336, the video encoder inserts splice points at every Group of Pictures (GOP), as shown in FIG. 6. A GOP consists of generally one I frame and a series of P and B frames, based on parameters set within the MPEG scheme. Preferably, the GOP is encoded as a “closed” GOP structure, which means that the GOP concludes on a P frame. Therefore, no motion vectors to the next GOP are present. If motion vectors cross from one GOP to the next GOP, artifacts are created and visible when the screen is switched. Thus, a closed GOP structure is necessary for compliance with MPEG syntax and to ensure the absence of visible artifacts after execution of the splice.

The GOP length is programmable and can be within 1 to infinite frames of video. It is preferred, however, that the GOP comprise 10-15 video frames. Referring to FIG. 6, four video signals are shown. It is desired that a seamless switch be made from any video signal to any other video signal.

As shown in FIG. 6, seamless video switching occurs on a GOP video-frame boundary. For pre-recorded material, splice points need to be identified for switch points. For programming where “free” channel selection is required (e.g., sports), all GOP boundaries are encoded as splice points. While the switch must appear seamless, it need not occur immediately. For example, a command or key input requires a finite time for processing. Therefore, a video switch may be delayed by up to 1.5 GOP's.

As shown in FIG. 6, splices take advantage of the non real time nature of MPEG data during transmission through the digital channel to create a time gap 340 in which the decoder can be switched from decoding one stream to decoding the other during the gap 340. Thus, the gaps 340 shown in FIG. 6 represent the switch times. The key is that the most complex video is completed and through the channel before the first packet of the next GOP is through the channel. By encoding at a lower bit rate than the channel capacity, some extra time is created at the end of the GOP in order to switch. In this way, two MPEG streams are merged to create a single syntactical correct MPEG data stream. These gaps can be created at the encoder 312, shown in FIG. 5, using any compression scheme.

The audio signals, preferably, are encoded using the AC3 format. The present invention, however, covers any conventional audio encoding scheme.

All of the various video, audio and data signals are digitized and combined in the encoder 312, in FIG. 5. Preferably, the compressed and encoded signal is output in DS3, Digital High Speed Expansion Interface (DHEI) or any other conventional format. The data type is not important, it is just data. The encode process then outputs a digital data stream at the appropriate bit rate for the target channel.

The modulator 320 may utilize one of several different possible modulation schemes. Preferably, 64-QAM is chosen as the modulation scheme. If so, the data rate at the output of the modulator 320 is around 29.26 Mbps. However, any of the following modulation schemes, with respective approximate data rates, or any other conventional modulation scheme (such as FSK, n-PSK, etc.) can be used with the present invention.

| Modulation Scheme | Rate |
|---|---|
| 64-QAM | 29.96 Mbps |
| 256-QAM | 40 Mbps |
| 8 VSB | 19.3 Mbps |
| 64 QAM PAL | 42 Mbps |
| 256 QAM PAL | 56 Mbps |

Separate NTSC channels are then combined in a conventional combiner, preferably using frequency modulation. Thus, seamless switching at the set top converters can occur from one signal to another within one NTSC channel or from one NTSC channel to another NTSC channel, as discussed below.

In summary, seamless switching at the decoder is facilitated at the encoder 312 by time synchronizing the signals, time locking the encoders and creating a time gap 340 to each of the digital video streams (which represents the difference between the encode rate and the channel capacity) to GOPs, defined below.

After encoding, modulation and multiplexing, the signals can be transmitted to reception sites via satellite, wireless, land line, broadcast, or any other conventional transmission system. In the preferred embodiment, the signals are distributed to remote sites via cable or other transmission media.

Reception Sites

At the reception sites, preferably consisting of the elements shown in FIG. 7, the signal is received via a tuner mechanism 344. The tuner 344 may be a wide band tuner, in the case of satellite distribution, a narrow band tuner for standard MPEG signals, or two or more tuners for seamlessly switching between different signals located in different frequency channels, as explained below. In the case of MPEG signals, the tuner 344 tunes to the particular NTSC channel indicated from command by the host processor 360. The host processor 360 is preferably a Motorola 68331 processor, but may be any conventional processor including PowerPC, Intel Pentium, etc.

The signal is then forwarded to the demodulator 364. The demodulor 364 demodulates the combined signal, strips off the FEC and forwards the digital signals to the video and audio decoder 372. At the digital decoder 372, the signals are separated and decompressed. The decoder 372 strips off the program identification number (PID), and routes these PIDs to the appropriate decoder, whether video, data, audio or graphics. The audio is preferably forwarded to the Dolby digital processing IC 380. The selected video and audio is then decoded, as explained below, and the video is sent to the video digital-to-analog (D/A) converter 388 which prepares the selected video for display.

A phase lock loop (PLL) recovers the encode clock, which was encoded in the PCR portion of the MPEG adaptation field. Preferably, a ROM holds the operating system for the reception unit 342 and is backed up with Flash-ROM to allow for downloadable code. Further, there are memory devices connected to the decoders 372, 380 and graphic chip 376, which are used to store graphics overlays, for example. Furthermore, profile data for various users in the home can be stored in nonvolatile RAM or ROM 352.

A backchannel encoder and modulator 368 are present for sending data back to the headend. Such data may comprise personal profile information, interactive selections, demographic data for targeted advertising purposes, game show scores, etc.

Further, the reception unit 342 permits new software applications to be downloaded to the unit. These applications can control the unit and redefine the functionality of the units within the constraints of the hardware. Such control can be quite extensive, including control of the front-panel display, the on-screen display, all input and output ports, the MPEG Decoder, the RF tuner, graphics chip and the mapping of the IR remote functions.

Preferably, the interactive programming technology, including providing for multiple camera angles, individualized advertising, etc., of the present invention is implemented as a software application within the reception unit 342. Such technology is preferably located within ROM or Flash-ROM 352 of the reception unit, shown in FIG. 7. The interactive technology, however, could alternatively be located in any type of memory device including RAM, EPROM, EEPROM, PROM, etc. As such, the software shall have access and control over the hardware elements of the device. In the preferred embodiment, no additional hardware is required for full use of the interactive programming technology within the reception unit 342 to achieve the performance described above.

Any type of conventional remote control device 348 can be used with the present invention. It is preferred, however, that the remote control device 348 be an infrared (IR) device and include four or more option buttons and their associated IR codes.

Seamless video switching at the reception unit 342 is explained in the paragraphs below. The reception unit 342 shown in FIG. 7 preferably is capable of real-time MPEG-2, MPEG-4 or MPEG-7 decoding. The reception unit 342 monitors user interactions and information transmitted from the program source and seamlessly switches video and audio streams as appropriate.

Based upon the viewer's responses and requests, the unit automatically and seamlessly switches between video, graphics and audio programming sequences reflecting the viewer's earlier responses. The interactive technology of the present invention permits a high level of interactivity while not requiring the set top unit 342 to transmit any information back to the programming source.

In the video decoder 372, shown in FIG. 7, the header data is stripped off the MPEG stream. The particular video is then selected based on a command from the host processor 360. The associated audio is sent to the audio decoder portion 380. The selected video is buffered in a standard video buffer and then output for decoding. The physical buffer size is defined by the MPEG standard, herein incorporated by reference. Enough time must be allowed at the initial onset of decoding to fill up the buffer with I-frame and other data.

After buffering, the selected video goes through various steps of an MPEG decode process, which utilizes a variable length decode (VLD) preferably. Generally, the variable length decode converts the run-length encoded datastream and converts it into its longer bitstream format. The bitstream is decoded into its constituent parts i.e. motion vectors, dct coefficents and the like so that the video can be reconstructed. Subsequently, the datastream is converted into frequency domain information using an inverse Discrete Code Transform DCT filter. If the frames are interceded, the pixel data is generated and stored in a buffer.

Referring to FIG. 7, the seamless switch from one to another MPEG video stream is explained. Switches will occur on video splice points, as shown in FIG. 6. When the demux/decoder 372 in FIG. 7 sees the splice point, it switches to the selected video signal which is sent to the buffer. Thus, prior to the switch, the first video signal frames are still being buffered. The next signal PID is loaded into the decoder 372 from the host processor 360. In order to accomplish a switch to one of the four video streams, the video decoder 372, shown in FIG. 7, must identify the PID number of the new video stream. Further, it is preferred that each incoming video and audio stream shall have its own PID, known to the interactive application stored in memory at the set top converter 342, in order to facilitate seamless switching among the independent video and audio streams. It must then call the routine that performs the switch. This next PID, identifying the next selected video signal, can be based on either user selection or by way of the interactive control codes or both. Once the next PID is loaded, the decoder 372 begins to look for the selected video stream and, because of the gap 340 created in the video datastream, the decoder 372 will always find the header information of the next video. Once the splice point indicator of the first video is seen by the decoder 372 and the second video signal is identified by the decoder 372, the second compressed video signal begins to load into the buffer as the first video signal continues to plays out. The new video signal is selected based on either user selection or based on an interactive control code.

One of the items necessary for a seamless switch is the splice point counter and a splice point flag. Both of these indicators are placed in the adaptation field of the MPEG video streams. The splice point counter indicates the number of video packets prior to the splice point. The splice point flag indicates that the splice count is present in the stream. Once the decoder 372 determines the splice point, it can begin buffering the next video stream and continue decompressing the signal as if it were one MPEG stream.

Audio Switching

As with the video streams, preferably four AC-3 audio streams, each of which is identified by a unique PID, exist per service. PID numbers are obtained from the MPEG-2 transport table such as SI, PG, and PM at the invocation of the interactive service. One of these PIDs is selected as the default audio channel and is selected upon acquisition of a service. The remaining three channels are optional and shall be selected by the Control Program based on Control Messages and/or User Input. While audio channels normally switch with the associated video channel, they may also be switched independently.

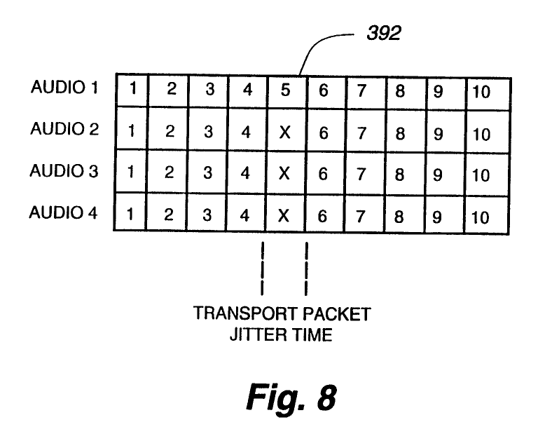

In the preferred embodiment, switching occurs on frame boundaries, as shown in the digital frame representation 392 of four audio streams of FIG. 8. When switching from one channel to another, one frame may be dropped (in this case, frame 5), and the audio resumes with frame 6 of the new channel. The audio decoder 380 is capable of audio switching by provision of the insert of audio splice points at the encoder 312, shown in FIG. 5. Preferably, the encoder 312 inserts an appropriate value in the splice countdown slot of the adaptation field of the current audio frame.

When the audio decoder 380 detects this splice point the decoder 380 may switch audio channels. Although the audio splice is not seamless, the switch will be nearly imperceptible to the user.

Data Commands

Because the data commands are time sensitive in the digital embodiments, they are sent from the headend via a command data PID (Packet Identification). The commands must be synchronized with video GOP's at the encoder end. In order to accomplish this, the data codes computer 316, shown in FIG. 5, must send individual commands as a whole packet. Each command can consist of as few as two bytes. Therefore, the generator must pad the rest of the packet with code FF (hex) bytes. When this whole packet is sent to the encoder 312, the encoder 312 will transmit it at its earliest convenience. If a partial packet is sent to the encoder 312, the encoder 312 does not send the command until subsequent commands filled the remainder of the packet.

The commands, as identified in (1) ACTV Coding Language, Educational Command Set, Version 1.1, and (2) ACTV Coding Language, Entertainment Command Extensions, Version 2.0, both of which are herein incorporated by reference, are formed by stringing together two to six byte long commands. The command data is presented to the encoder's ISO interface and packet stuffed to ensure timely transmittal of the command data.

The Control Program is preferably stored in RAM 352. The processor 360 receives instructions from the Control Program. Further, key inputs such as user responses, personal profile information as well as control messages are used by the processor 360 in making switching decisions.

Preferably, the Control Program operates in five modes as determined by the received interactive command messages. The five modes are as follows:

Switch Audio and/or Video Based on User Input

Switch Audio based on User Input and stored data

Switch Audio and/or Video based on User Input and stored data

Switch Audio and/or Video based on Control Messages

Switch Audio and/or Video based on Control Messages and stored previous input.

Multiple modes may be used by the Program simultaneously.

The first mode above, switch audio and video channels, is the simplest mode of operation. The Control Program is commanded by the microprocessor 360 to accept one of the four Remote input key codes and to switch to the corresponding audio/video channel. The Program performs this switch on the video frame boundary at the end of the current GOP. Once the new channel is displayed, the Program has the capability to update the On-screen display with new text and/or graphics messages either received in the datastream from the headend or stored locally.

The second mode above, Display One Video Channel and Switch Audio Channels, continuously displays a single video channel. When a remote input key code is received, the video continues but the audio channel is switched on the appropriate audio frame boundary. As mentioned above, the appropriate audio frame boundary is determined by examining the splice point counter value in the adaptation field. The choice made by the user is stored in a RAM register. Any time a choice is made by the user, the key code and the previously stored choices are reviewed by the Program to determine the next audio channel.

The third mode identified above, Switch Audio/Video Channels Based on User and Previous Choices, displays an initial audio/video channel. When commanded by the Command Message stream, text is displayed on the On-Screen display. The Program then waits for a user input. When the user input is received, it is stored in a RAM register along with previous user choices. The register is examined by the Program and then, based on stored logic, determines the next audio/video channel to be displayed.

The fourth mode identified above, Switch Audio/Video Channels Based on Control Messages, also displays an initial audio/video channel. The Program then waits for a control input from the Control Message stream. Based on this input, the Program switches channels on the video frame boundary at the end of the current GOP.

The fifth mode above, Switch Based on Control Messages and Previous Choices, displays an initial audio/video channel. The Program then waits for a control input from the Control Message stream. When the Control Message input is received, it is stored in a RAM register along with the previous user and control message choices. This register is then examined by the Program to determine the next audio/video channel to be displayed.

Digital Video Systems and Applications

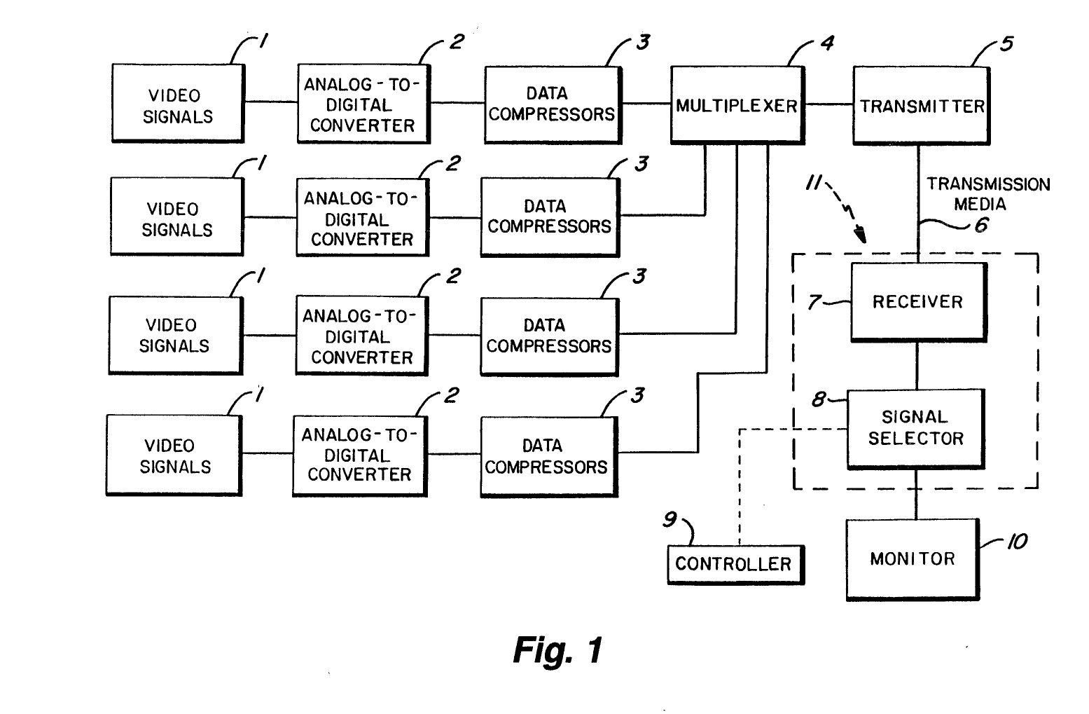

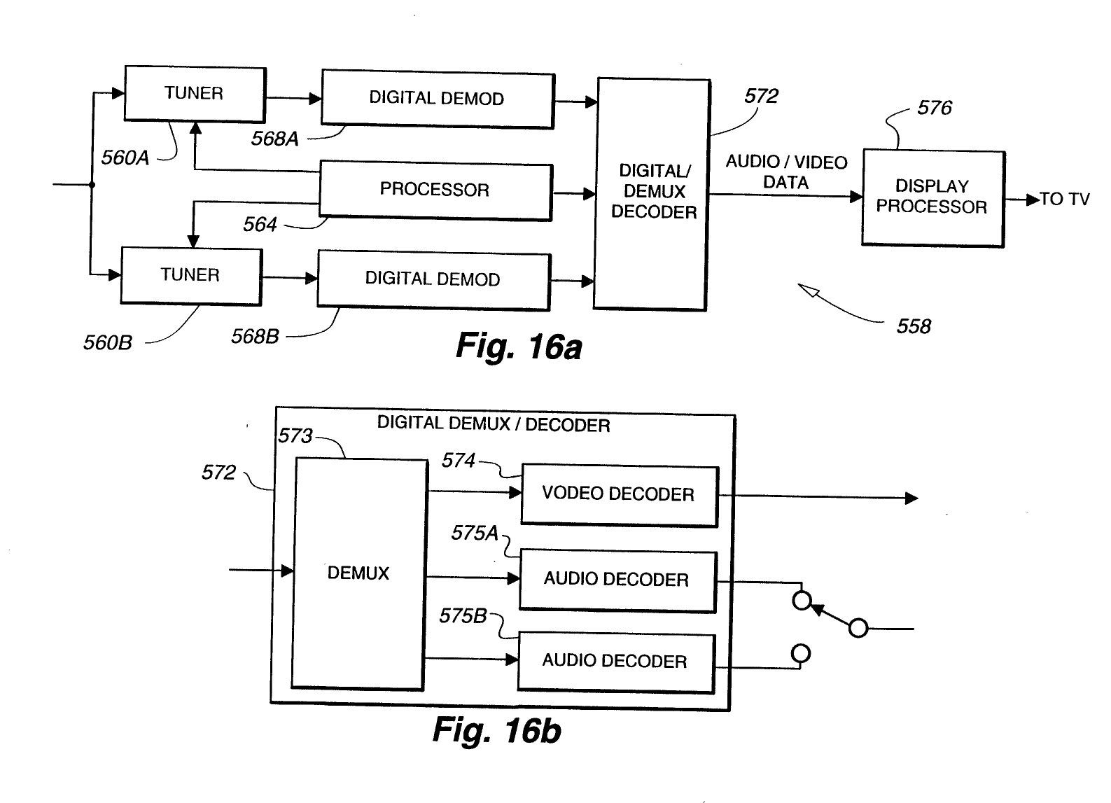

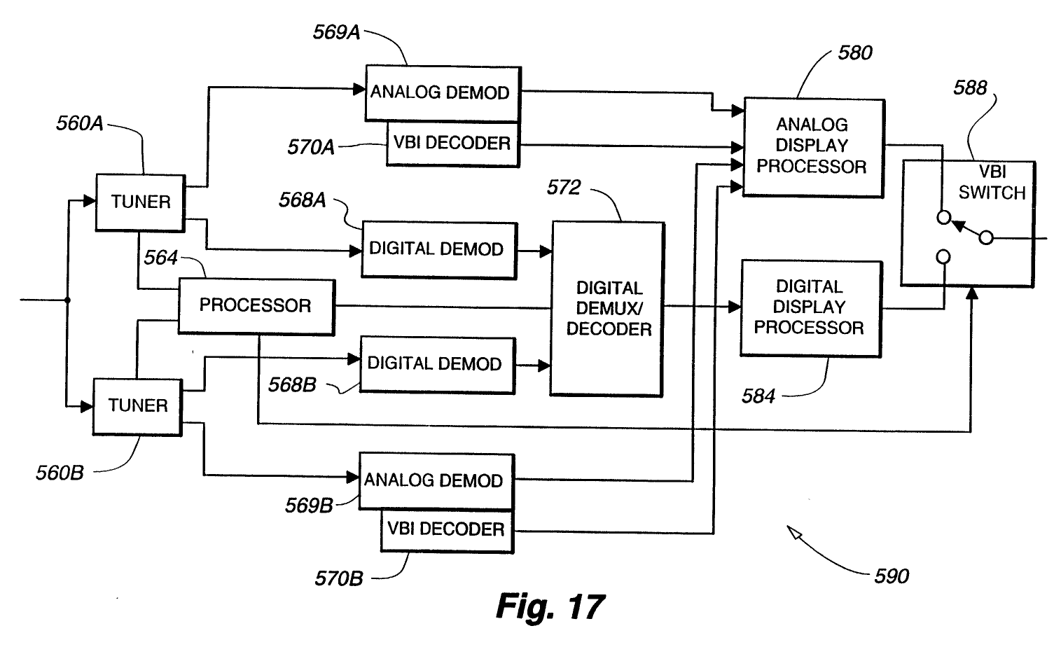

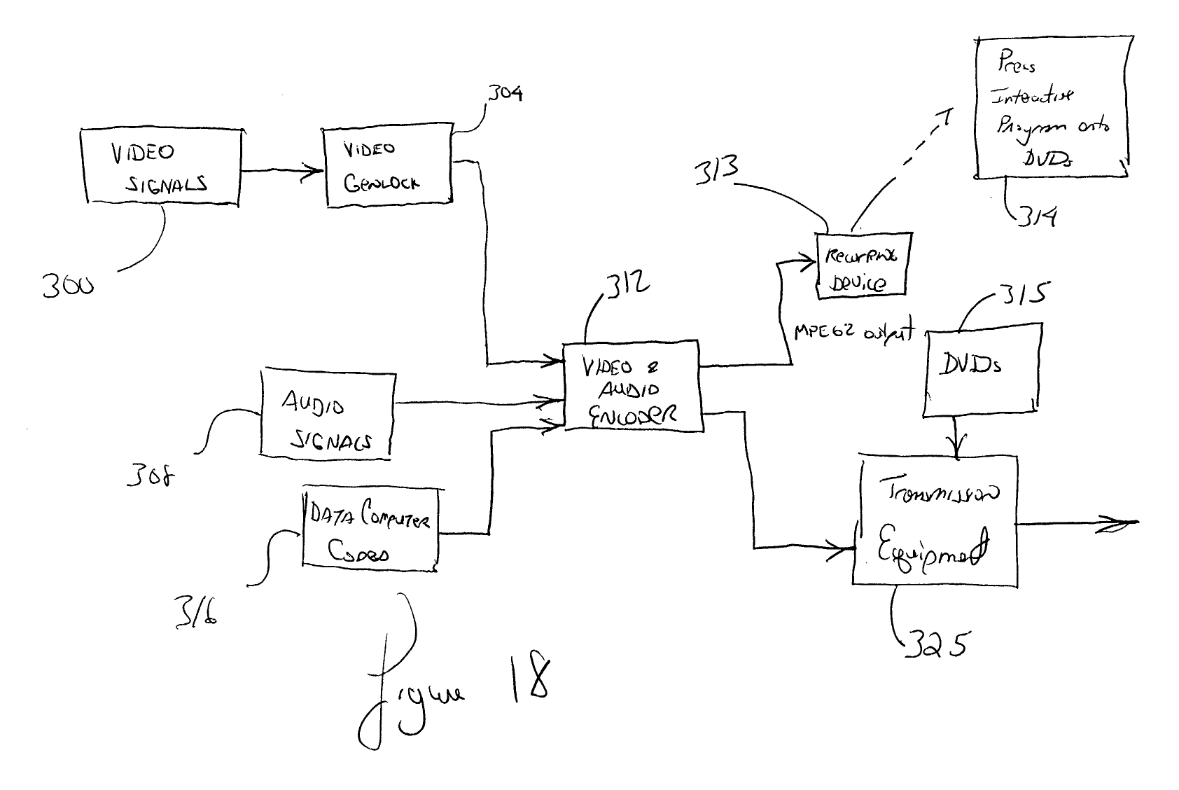

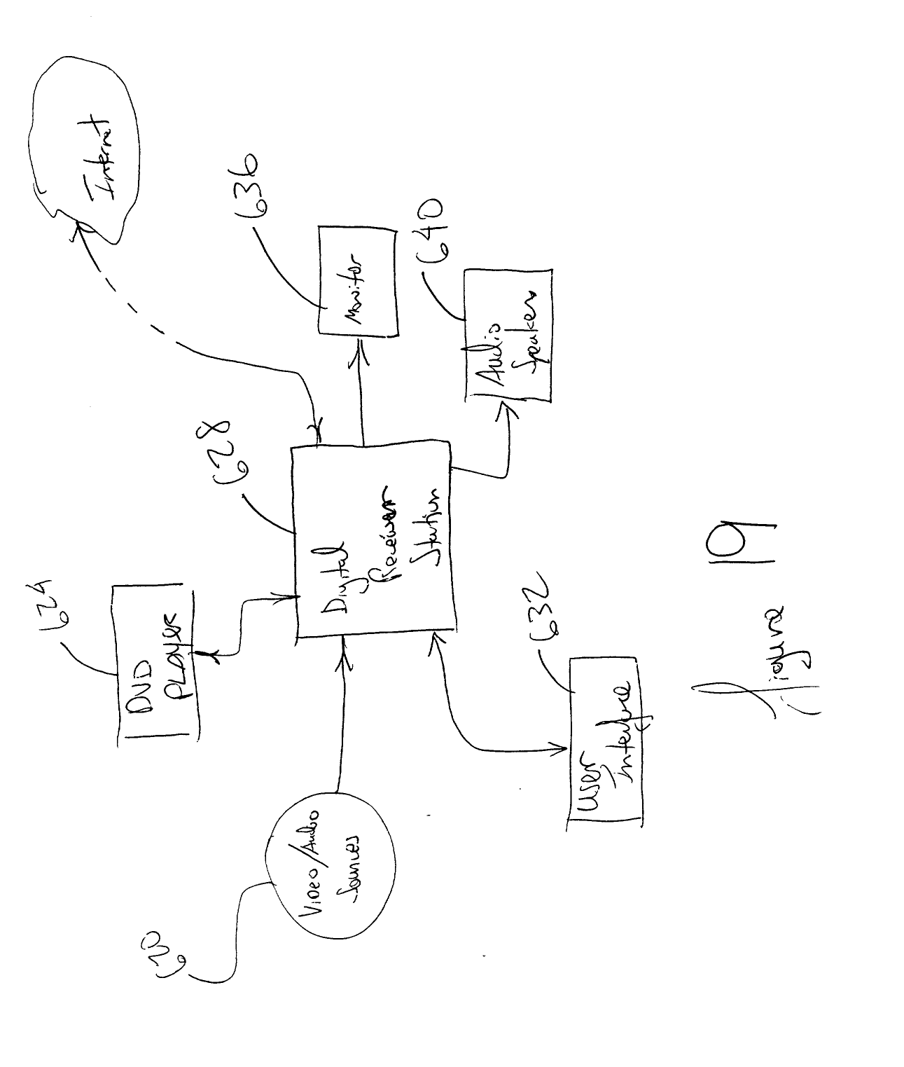

The following paragraphs disclose several applications using the digital embodiments disclosed above in FIGS. 1-8 and the two tuner embodiments, described below, of FIGS. 16 and 17.

TV Broadcast Station Switching

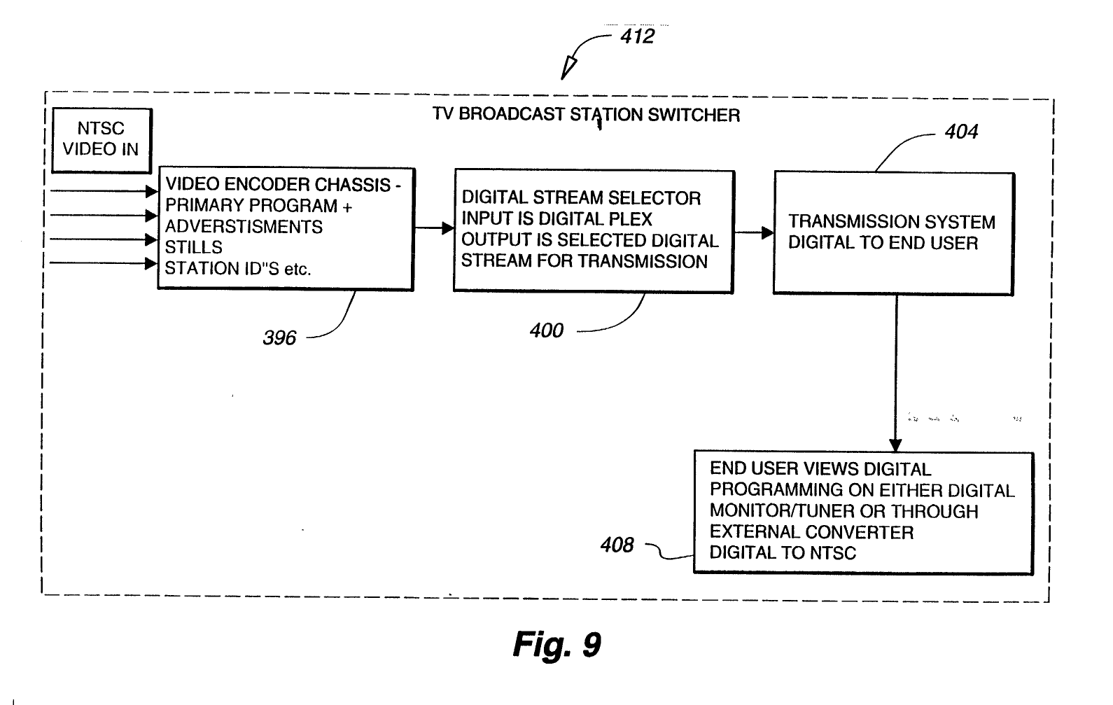

In this embodiment 412, the seamless switch from one signal to another signal is done at a TV broadcast control center and forwarded to the users' digital reception sets 408, as shown in FIG. 9. At the headend 396, several digital programs are combined according to any of the methods explained above.

Upon receipt of the programs by the broadcast station, the signals are fed into a digital stream selector 400. This selector comprises the elements discussed above in any of the alternative embodiments for performing a seamless switch (FIGS. 1-4, 7, 15-17), except for the fact that this unit is not located at the remote sites. The unit works in the same manner as discussed above. Regardless of whether the digital stream selector 400 selects amongst multiplexed signals in one datastream on one channel, centered on a certain frequency, or between signals in different datastreams, or from a received signal to a locally inserted ad, all such switches are seamless in the embodiment shown in FIG. 9. As discussed above, selections can be made as a function of station prerogative, remote user selections and/or personal profile information (transmitted to the TV station via a backchannel), or targeted advertising.

Once a selection is made the program signal is transmitted by any conventional means 404 to the remote sites 408 for presentation.

Non-related Program Switching

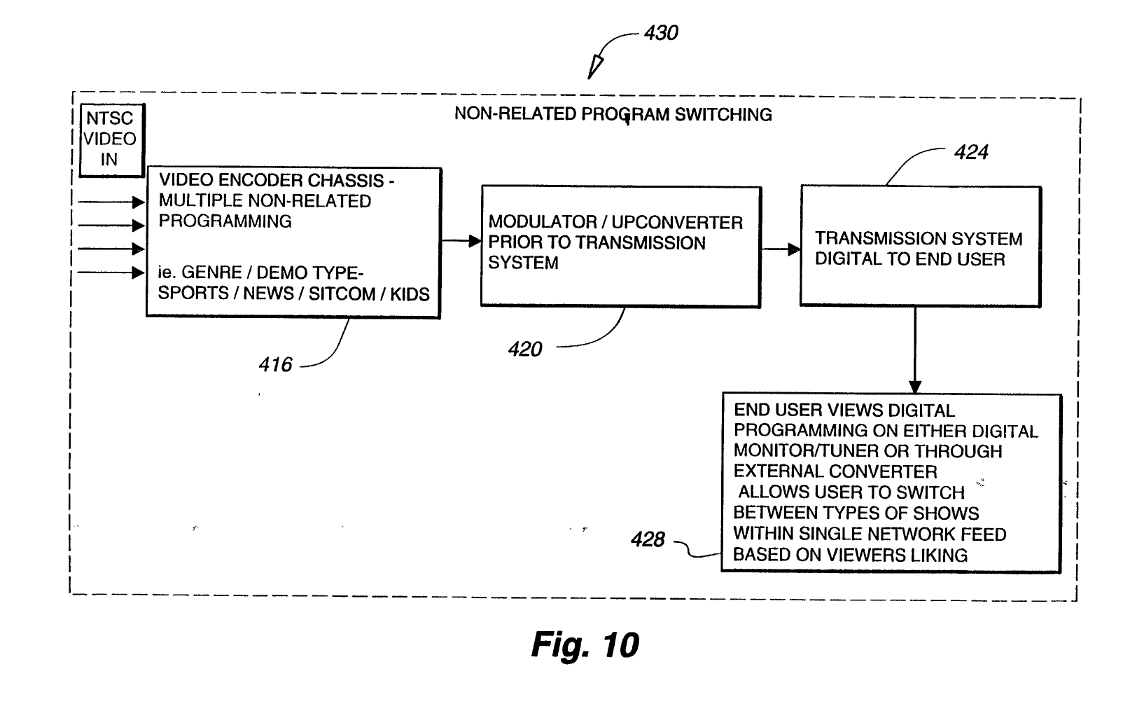

FIG. 10 discloses an embodiment 430 for switching between non-related programs. In other words, this is simply switching from one TV channel to the next TV channel. Presently, switching from one signal to another cannot be accomplished without flicker in the digital environment.

In the present invention, a viewer may switch from one program to another program, whether related or unrelated, and the transition will be seamless. In other words, there will be no visible artifacts present in switching from one program to another program.

If the programs are compressed and multiplexed within one MPEG stream, any of the embodiments disclosed herein are capable of performing the seamless switch. If the programs are in separate NTSC channels, one of the digital “two tuner” embodiments (FIGS. 4, 16 and 17) must be used to allow for the frequency shift.

The high level elements of the system 430 for non-related program switching are shown in FIG. 10. Preferably, the non-related programming is compressed and multiplexed using an MPEG stream into one datastream using one NTSC channel at a video encoder chassis 416. Non-related programming can be combined into one MPEG stream or can be in directed into different NTSC channels. For example, programming may consists of sports, news, sitcom or children's programming. These programs are modulated at a modulator/upconverter 420 and transmitted across any suitable transmission means 429 as discussed above.

End users are capable of viewing digital programming on either a digital monitor/tuner, a personal computer or through an external converter 428, connected to an analog television set, in which case the seamless switch is performed in the converter. Either of these various components allows a user to “surf” channels based on a viewer's preferences. Again, the reception unit can be selected from any of the alternatives explained in FIGS. 1-4, 7, 15-17.

Seamless Switching within Multiple Event Programming

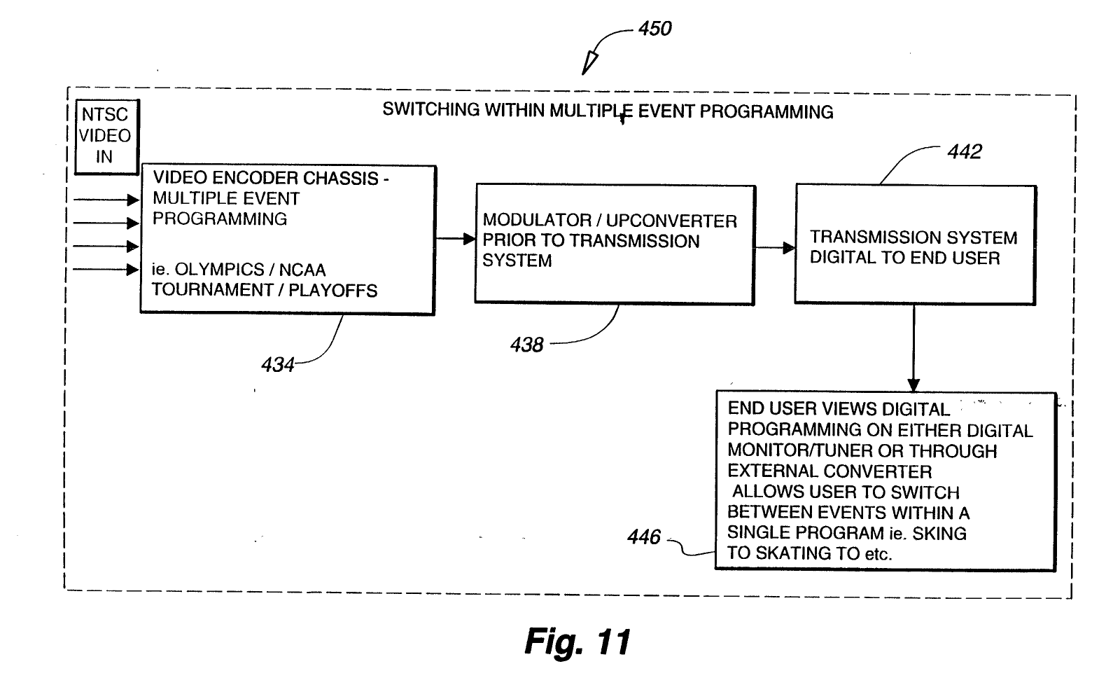

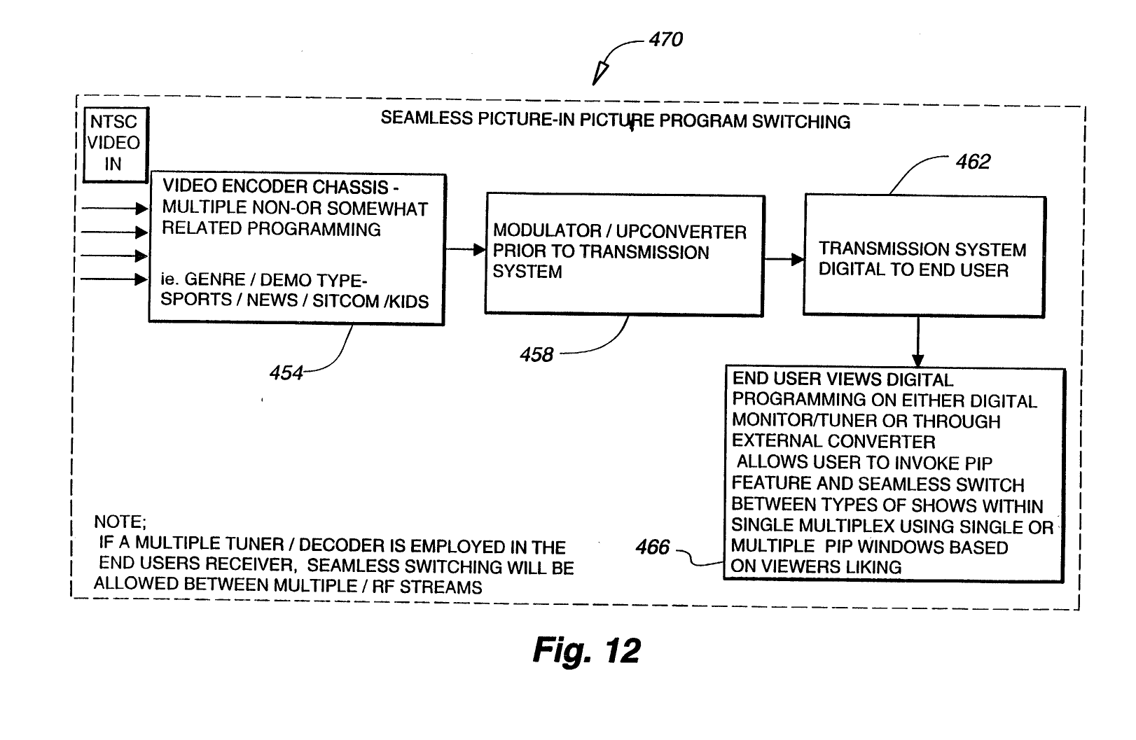

In this application, shown in FIG. 11, a system 450 is provided for allowing a user to switch between separate events within a single program. For example, an Olympics broadcast may simultaneously comprise several programs corresponding to different events, e.g. skiing, speed skating, figure skating, ski jumping etc. Preferably, these separate event programs are compressed and multiplexed into one MPEG digital stream at the video encoder chassis 434, passes through the modulator/upconverter 438 and transmitted as a single NTSC signal via the transmission means 442. These event programs, however, may also be encoded at the broadcast center onto separate NTSC channels.

After modulation and subsequent transmission, these programs are received at the remote sites 446. The remote sites 446 include a reception unit, which contains either a digital monitor/tuner, a personal computer, or a external digital converter connected to a monitor. The user may select between the different programming events via his or her remote control device. When the user desires to switch to another event program, the switch will be performed seamlessly according to any of the methods and systems discussed above (FIGS. 1-4, 7, 15-17).

Seamless Picture-in-picture Program Switching

FIG. 12 discloses an embodiment 470 for switching between preferably non-related programs using “picture-in-picture”. Regardless of whether the user is switching between programs in the small framed display or the large framed display, all such switches are seamless with the present invention.

In the present invention, a viewer may switch from one program to another program in either of the two displayed windows. In other words, there will be no visible artifacts present in switching from one program to another program.

The high level elements of the system for picture-in-picture program switching 470 are shown in FIG. 12. Preferably, four to seven programs are compressed and multiplexed into an MPEG stream into one datastream on one NTSC channel at the video encoder chassis 454. Other programs are combined into other MPEG datastreams at the video encoder chassis 454. For example, programming may consists of sports, news, sitcom or children's programming.

These programs are modulated and transmitted across any suitable transmission means 462, as discussed above.

End users are capable of viewing digital programming on either a digital monitor/tuner, a personal computer or through an external converter 466, connected to an analog television set, in which case the seamless switch is performed in the converter. The embodiment and flow disclosed in FIG. 12 allows a user to invoke the picture-in-picture feature and seamlessly switch between different programs within a single MPEG stream. If switching from one MPEG multiplexed stream to another is desired, the converter, PC or digital monitor/tuner 466 will require the employment of a multiple tuner/decoder, examples of which is shown in FIGS. 4, 16 and 17.

Switching within Multiple Commerce/Shopping Programming

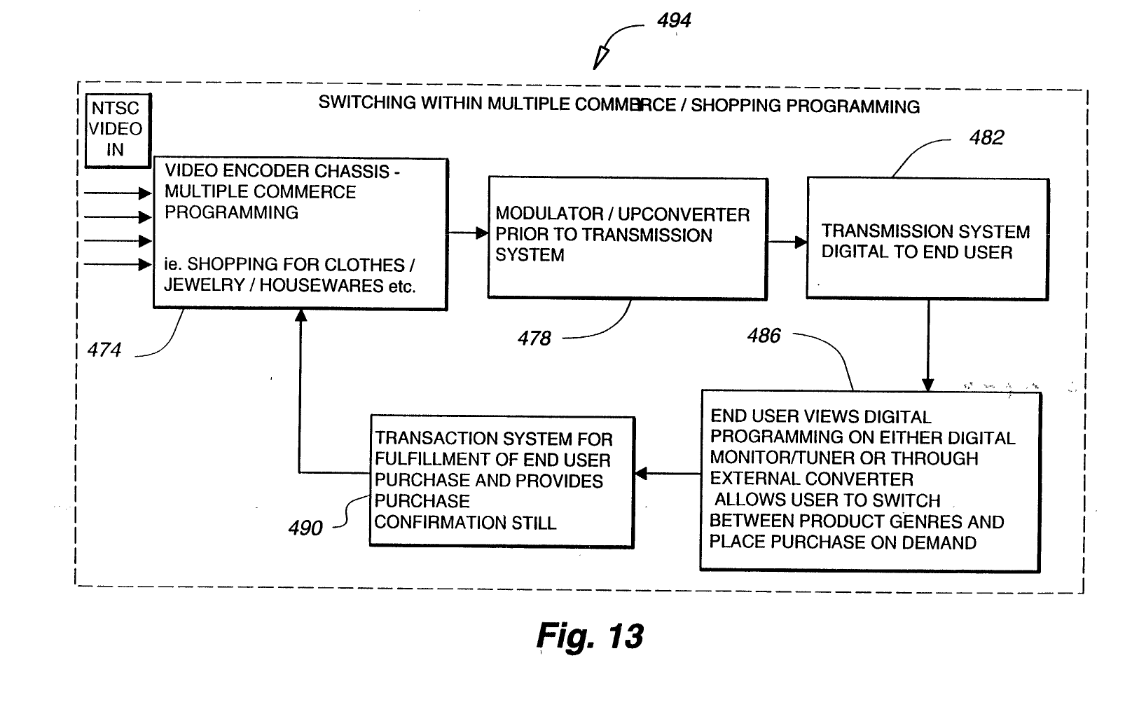

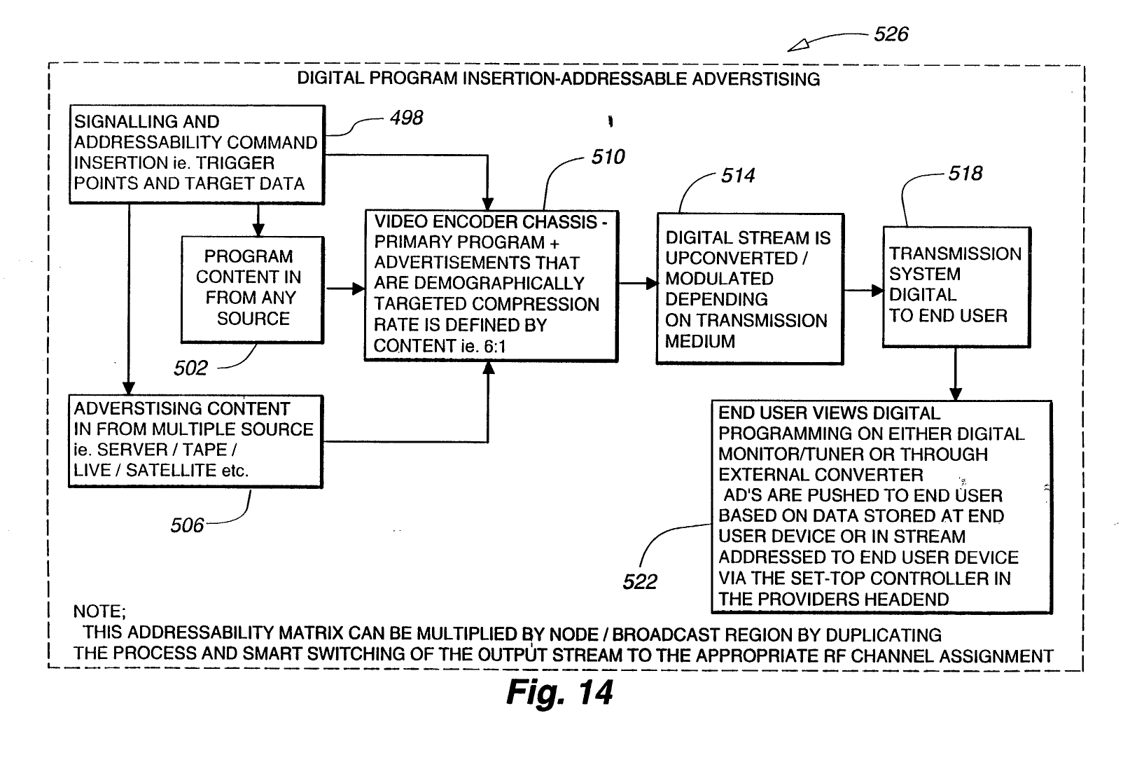

One application of the current invention involves a transaction based system with return paths, as shown in FIG. 13. As with the other embodiments discussed above, the video encoder 474 compresses and multiplexes several different programs onto one or more NTSC channels for transmission to the remote sites.

Preferably, several different types of shopping programs are compressed and multiplexed onto a single NTSC channel. For example, separate programs may be directed at clothes, jewelry, housewares, etc. If more programs are necessary than allowable on a single NTSC channel, more than one NTSC channel may be utilized by the present invention.

The programs are transmitted to the end user reception units 486, as shown in FIG. 13, over any suitable transmission means 482. At the reception units 486, the user can seamlessly switch between different product genres. Alternatively, the reception unit 486 can switch to certain product programming based on personal profile or demographic information. In this manner, only those products which most closely match or suit a particular individual's interests and desires will be presented to the user. Such data can be stored in either storage in the reception unit 486 or at the headend.

If the user determines that he or she would like to purchase or receive additional information regarding a product, the backchannel 490, such as that shown in FIG. 10, can be used to transmit such requests back to the central location.

Digital Program Insertion—Addressable Advertising

FIG. 14 discloses an embodiment 526 for providing digital program insertion. At certain predetermined times during the programming, certain advertisements are displayed to the viewer. In the preferred embodiment, advertisements are individualized to the particular viewer based on personal profile information or demographic information. Such targeted advertising is described in the following paragraphs.

At the central location, a plurality of advertisements is inserted into the programming stream. Preferably, the central location uses a hybrid digital insertion system for insertion of the advertisements into the programming. Hybrid digital equipment replaces the tape decks of the analog system with computers, disk drives and decoder cards, as set forth in the CableLabs Cable Advertising White Paper, herein incorporated by reference. The advertising content 506 may originate from any one of a number of possible sources, including, but not limited to, server, tape decks, satellite feed. For storage, preferably the spots are digitally encoded and compressed in an off-line process, using MPEG1, MPEG1.5, MPEG2, or a proprietary method. Distribution from the encoder to the server and to the playback systems can be done through a network or by disk or tape.

After encoding, the spots are distributed to a server for storage until required for playback. Preferably, a spot can be played directly from the server to a decoder card, for conversion back to analog. The spot is converted to analog, then sent through the insertion switcher in the conventional manner. The output video and audio would then be forwarded to the audio and video encoder shown in the central site configuration in FIG. 5, after which the spots are digitally encoded and compressed as described in the paragraphs above, with reference to FIG. 5.

Although not as efficient as digital advertising insertion, the actual switching of the advertising into the programming can also be accomplished with conventional advertising insertion systems, using analog or tape based systems.

The placement and display of advertisements into the programming stream are controlled through the use of signaling and addressability command insertion 498. Personalized advertising can be effectuated by addressing certain advertisements for certain viewers. For example, a certain car company wants to individualize its commercial to best meet the needs and desires of the viewer. If it is known that a particular user is male and enjoys outdoor activities, the programmer may want to show the advertisement corresponding to the Car Company's Sports Utility Vehicle as opposed to a small economy car. The advertisements can be pushed to the end user based on data stored at the remote end user unit or in the stream addressed to the end users device via the set-top controller in the provider's headend.

Preferably, several advertising options are encoded according to the manner described above with reference to FIG. 5. Because the advertising spot videos are genlocked and time synched at the encoder 510, switching from the main programming to one of the advertisements will appear seamless to the viewer.

Seamless Switching from a Group of Signals to Another Group of Signals at a Server

In another embodiment of the present invention, the process of switching among live and served video content is described. As opposed to switching from a single digital signal to another single digital signal at the remote reception units, this embodiment allows for a seamless transition from one group of signals to another group of signals. It is necessary that the transition take place in a manner such that the output bitstream is continuous and correct to the MPEG syntax. Proper switching ensures that any standard MPEG decoder plays the resulting bitstream as if it were a stream with no errors.

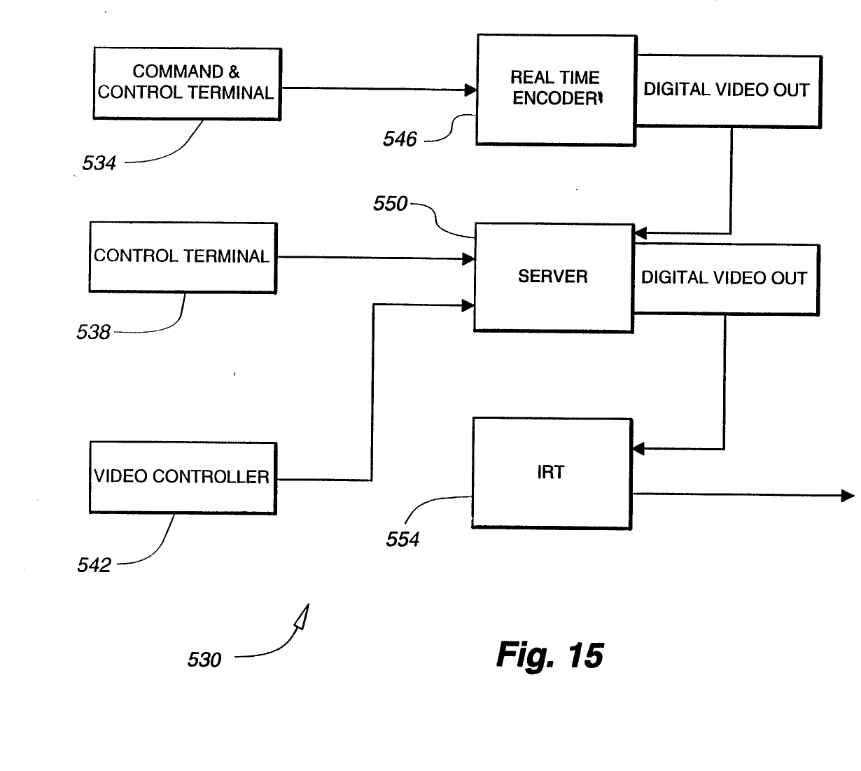

The preferred embodiment 530 for performing this switch is shown in FIG. 15. The elements of FIG. 15 are located at a cable headend or alternatively, at a centralized op center for a satellite distribution network. For purposes of explanation, a group of live signals are denoted as the Group A signals and the Group B signals are presumed to be stored prerecorded signals, preferably stored at the server 550. For example, the Group A signals may comprise several videos representing different camera angles at a sporting event. The Group B signals may represent a series of commercials. It is understood, however, that both the Group A and/or Group B signals could represent either prerecorded or live signals.

In this embodiment, it is desired to switch from the Group A signals to the Group B signals. The Group A signals are received at the server 550 from a real time encoder 546, located either locally or at a remote site. A specialized MPEG digital packet is inserted into the Group A content stream on a specific channel. The Command and Control terminal 534 provides an analog tone in the video signals prior to analog-to-digital conversion. Once the signals reach the Real Time Encoder 546 from the Command and Control terminal 534, the Real Time Encoder 546 inserts a digital tone at the appropriate point in the Group A digital stream upon detection of the analog tone. Once the tone is inserted, the Group A digital stream is output from the Real Time Encoder 546 and forwarded to the Server 550 at the headend. Once received at the server, the Group A stream is forwarded to an MPEG transport switch device in the server 550. The Control Terminal 538 sends a command to the MPEG transport server switch device to cause the switch to begin looking for the inserted digital tone.

In order to play back the Group B content, the server switch device must decode timing information from the Group A digital stream and subsequently, restamp the Group B content with the appropriate timing signals from Group A. Preferably, this is accomplished by genlocking to the PCR's videostream, preferably the same stream with the digital tone embedded therein, and stripping out the program clock reference (PCR) out of the videostream to recreate the encode clock of the original Group A content. At this point, the switch device has the ability to re-insert the timing information into the Group B content to prepare it for playout.

Upon detection of the digital tone, the server switch device initiates a transition to the Group B digital stream, comprised of the Group B prerecorded signals. Preferably, the server switch device has prior knowledge of the length of the Group B content and, therefore, when the server switch device senses the end of the Group B content, it switches back to the Group A content. The resulting digital stream output from the server to the transmitter comprises both Group A and Group B content. The transmitter 554 forwards the digital data stream to the remote reception sites, as previously described.

In this manner, at certain times during the presentation of a sporting event, represented via the plurality of live digital video signals (i.e., the Group A content), for example, the received videostream at the receive converter units will automatically transition to the Group B prerecorded content based on the action by the server switch device, for example. The decoder at the reception sites then selects one of the advertisements in the Group B content, as previously described. At the end of the advertisements, the decoder automatically begins receiving the Group A content again and selects one of the live signals, as previously described. In this manner, a seamless switch from live encoded video content to prerecorded content is effectuated at the server.

Two Tuner Embodiments for Seamless Switching

Digital Stream to Digital Stream Switch

A two tuner embodiment 558 for providing seamless switching from a digital signal located in one frequency channel (hereinafter, “Channel A”) to another digital signal located in another frequency channel (hereinafter, “Channel B”) is shown in FIGS. 16A and 16B.

As shown in FIGS. 16A and 16B, this embodiment comprises two tuners 560A, 560B (for tuning to separate frequency channels), a microprocessor 564 (for selecting the frequency channels and digital signals embedded therein), digital demodulators 568A, 568B (for demodulating the signals from the carrier), a digital demux/decoder 572 (for stripping out the selected audio, video and data of the selected content from the composite digital stream) and a display processor 576 (for formatting the video signal for display).

This embodiment operates to switch from one digital data stream in Channel A to another digital data stream in channel B as follows. A first tuner 560A is tuned to Channel A and is receiving a composite digital stream, preferably comprising a plurality of digital video, audio and/or data signals, in the associated frequency channel. The composite digital stream is passed from the first tuner 560A to a digital demodulator 568A. The type of demodulation can be any of those conventionally known in the art, such as those described above.

The composite digital stream is then directed to the input of the digital demux/decoder 572, wherein the selected audio and video signals are stripped from the composite digital stream in a demux 573 and forwarded to the audio and video decoders 575, 574, respectively. Those signals are then decompressed and decoded based on the signal encoding scheme, preferably one of the MPEG schemes. Once decoded, the audio and video (and/or data, if appropriate) are forwarded to the display processor 576 and subsequently to the monitor.

Once a decision is made to switch to another digital signal in frequency Channel B, the microprocessor 564 sends a command to the second tuner 560B to pretune to the Channel B frequency. The composite digital stream in Channel B is passed through the digital demodulator 568B and forwarded to the digital demux/decoder 572. At this time, the digital demultiplexer 572 receives both the digital streams located on Channel A and Channel B. Thus, if both Channel A and Channel B carried four digital signals, the demultiplexer 572 receives eight digital signals. The digital demultiplexer 572 receives a command from the microprocessor 564 indicating which of the digital signals to strip out from the composite digital stream from Channel B. Separately, the digital demultiplexer 572 strips out the selected video and audio (and/or data) signals from the composite digital streams from Channel's A and B. The selected signals are forwarded to the video and audio decoders 574, 575. The video decoder 574 switches from the currently displayed video signal to the newly selected video signal as described above with reference to FIGS. 6 and 7. Therefore, the decoder 574 identifies the splice point in the present stream. Once the decoder 574 detects the splice point, it determines that it is the appropriate time to switch to the second stream. The decoder 574 begins loading the second stream into the buffer and a seamless switch is effectuated because of the time gap in the first stream. Once the second stream is output from the decoder, it is forwarded to the display processor 576, where the video signal is formatted for display.

The audio decoder 575 performs the switch from the present audio stream to the second audio stream, in the same manner as described above with reference to FIG. 11. Once the switch is completed, the second audio stream is forwarded to the display processor 576.

Switch from Analog Signals to Digital Signals or Digital Signals to Analog Signals

A two tuner embodiment 590 for switching from an analog signal located in a first RF channel to a digitally compressed signal in a second RF channel or vis versa is shown in FIG. 17. In this embodiment, a viewer is watching a particular channel, whether it be an analog or digital signal, in one specific RF frequency and there is a decision made to switch to another channel, whether it be analog or digital, in a different RF frequency. Two tuners 560A, 560B are used to transition from one RF frequency to a different RF frequency.

Assuming by way of example that the viewer is currently watching a channel (Channel A) with an analog signal and the decision is made to switch to a digitally compressed signal in a different channel (Channel B), the embodiment of FIG. 17 operates as follows. With respect to the analog signal, one of the tuners 560A tunes to the RF frequency associated with Channel A. Because the channel carries an analog signal, the tuner 560A directs the signal to the analog demodulator 569A and VBI decoder 570A. The analog demodulator 569A demodulates the analog signal using any conventional analog demodulation scheme known in the art. The VBI decoder 570A strips out any information (e.g., interactive commands, close captioning) embedded in the vertical blanking interval (VBI). The demodulated analog signal is then forwarded to the analog display processor 580, which formats the analog signal, and then outputs it to the VBI switch 588 and then display device.

If a decision is made to switch to a channel containing muxed and compressed digital signals, the microprocessor 564 determines the RF frequency location of this channel and forwards the information in a command to the second tuner 560B. Upon receipt of the command, the second tuner 560B pre-tunes to the indicated second RF frequency (Channel B). The output of the Channel B is forwarded to the input of the digital demodulator 568B, which demodulates the signal using any of the digital demodulation schemes known in the art. The digital data stream is output from the demodulator 568B and received at the digital demux/decoder 572. The microprocessor 564 sends a command to the digital demux/decoder 572 indicating the selected digital signal. The digital demux/decoder 572 demultiplexes the plurality of digital signals and decompresses such signals. The resulting selected constituent parts (audio, video and data) are then forwarded to the appropriate decoders 574, 575 (see FIG. 16B), as described above with reference to FIG. 16, whereby the video decoder 574 begins to decode the video information and sends a signal to the microprocessor 564 signaling that the stream was properly decoded and that the audio was in lip synchronization.

The video and audio signals are then forwarded to the digital display processor 584, wherein the signals are converted from digital to analog. The resultant analog signals corresponding to Channel B are then input into the VBI switch 588. Upon command from the microprocessor 564 to switch the two videos, the VBI switch 588 switches during the appropriate time during the vertical blanking interval, resulting in a switch from the analog to the digital channel.

If it is desired to switch from a digital channel to an analog channel, the process identified above is simply reversed and the second tuner 560B pre-tunes to the analog channel. Further, the embodiment shown in FIG. 17 can switch from analog to analog channels.

DVD Embodiment

In another embodiment of the invention, live or pre-recorded programs are automatically converted to DVD at the time of production or in subsequent edit editions at a central location, as shown in FIG. 18. In this manner, the live or pre-recorded programs can be converted to DVD for later playback. Further, the DVDs with embedded programs could be sold by distributors to consumers for home use. Because the DVD would preferably contain the ACTV control codes, any type of receiver station with the interactive embedded software described herein would be capable of local play back of the program off the DVD.

The process of pressing a live or pre-recorded program is preferably performed at a central location, the elements of which are shown in FIG. 18. The elements and procedure for developing the program are essentially the same as that described above with reference to FIG. 5; the difference being the pressing of the programs onto DVD. As shown in FIG. 18, a plurality of video signals 300 are shown which could comprise live or prerecorded video streams. The origin of the video signals could be from cameras (for live video), video servers, video tape decks, DVD, satellite feed, etc. The video signals can be in MPEG format, HDTV, PAL, etc. A plurality of audio signals 308 may originate from CD, tape, microphones, etc. Further, data comprising graphics signals and/or html/web site link addresses can be input into the video and audio encoder.

The data codes, shown emanating from the data code computer 316 in FIG. 18, are the interactive commands for interactive processing used by the set top converter, as discussed above. Preferably, the data codes are part of an interactive scripting language, such as the ACTV scripting language, originating in a coding computer 316. The data codes are also forwarded to the encoder 312. These data codes facilitate the multiple interactive programming options at the reception units. This embodiment requires a data channel for enabling a synchronous switch between a first video stream and a second video stream. This data channel comprises the codes which link together the different program elements and information segments on the different video signals.

Referring again to the video signals 300, the plurality of video signals 300 are genlocked in the video genlock device 304 and thus, time synchronized. The time synchronized video signals are directed into the video and audio encoder 312. In the preferred embodiment, compatible encoders 312 are required at the cable headend to work with the digital reception units at the remote sites. As discussed above with reference to FIG. 5, the interactive applications of the current invention are preferably facilitated by synchronizing the commands at the headend to a specific video frame and a specific audio frame. This level of synchronization is achievable within the syntax of the MPEG-2, 4 or 7 specifications. Further, the video encoders 312 are preferably time synchronized, as discussed above with reference to FIG. 5.

As shown in FIG. 5, multiple video signals 300, data codes 316 and audio signals 308 are input into the encoder 312. In the preferred embodiment, four video channels are input into the encoder 312. However, more or less video streams may be input based on the content that is to be delivered. Preferably, the encoder 312 uses a standard MPEG-2 compression format. However, MPEG-4 and MPEG-7 as well as other compression formats, such as wavletts and fractles could be utilized for compression. These techniques are compatible with the existing ATSC and DVB standards for digital video systems. Certain modifications, however, are made to the MPEG stream in order to facilitate the preferred seamless switching at the set top box. These modifications to the encoding scheme are described above with reference to FIGS. 5 and 6.

At the output of the encoder 312, the composite signal is directed to a modulator 325 for transmission to receiver station and/or is directed to a DVD production suite. Prior to DVD production, the compressed program is preferably stored on tape or other medium 313 and then sent to DVD production 314 for pressing of the program onto the DVD medium according to DVD standards conventionally known in the art.

Referring again to FIG. 18, once the program is converted to storage on one or more DVDs, the DVD can be played back at a central location (such as a cable headend) and the compressed interactive program comprising multiple audio, video, Html/web links, control codes and/or graphics signals stored thereon can be transmitted over any of the transmission means to any of the receiver stations disclosed herein. The composite interactive signal on DVD is output from the DVD Player 315 and transmitted over any suitable transmission means via the transmission equipment 325.

The interactive program pressed onto the DVD can be any of the types of programs described above, including recorded live sporting events (with alternative camera angles, closeups, replays, slow motion video, graphics with player statistics, etc.), interactive movies, games, etc.

Alternatively, the pressed DVDs can be sent to users and played-back locally, as shown in FIG. 19. In this embodiment, the ACTV control commands are ported to auto-convert to those of a DVD specification. A secondary data/command stream would be sent to the DVD production to later be used as the digital file master send to the DVD pressing house for distribution. In this manner, the resultant DVDs sold or otherwise distributed to consumers will prevent the ACTV methodology from being played over distribution networks.

Referring to FIG. 19, the interactive receiver station can be any of the receiver stations described with reference to FIGS. 3-4, 7, 16 and 17. In this embodiment, however, preferably the interactive program is stored on a DVD. The receiver station 628 could be a digital television, digital cable box with connection to a television, a computer, etc. The receiver station 628 is operably connected to a DVD player 624, as shown in FIG. 19. In this embodiment, seamless branching is preferably provided amongst the different MPEG encoded video signals stored in the DVD. Further, additional interactive elements can be stored on the DVD including, graphics, still images, links to Web pages, audio segments. The controller initiates the interactive program by sending a command to the DVD player 624. Preferably, the DVD player 624 forwards the MPEG encoded program to the receiver station 628 which separates the video, audio and data channels as described above with reference to FIG. 7. Alternatively, the DVD player 624 may perform the selection of the appropriate video/audio/graphics for display and forward to the digital receiver station 628 only the selected streams.

The controller reads the ACTV commands and selects interactive segments for display and audio play, as discussed above, based on the interactive commands it receives and user inputs and/or a personal profile stored either in the digital receiver station or external to the digital receiver station, including at a central location. Based on the commands, it plays the appropriate input from the DVD Player 624 and/or other indicated sources, e.g. the Internet. One or more of the commands may direct the controller to access information segments from an Internet source. Such Internet information segments may include graphics, text, audio and video clips. In this manner, information segments from the Internet can be integrated with the interactive program as described in U.S. Pat. Nos. 5,778,181 and 5,774,664, herein incorporated by reference.

Although the present invention has been described in detail with respect to certain embodiments and examples, variations and modifications exist which are within the scope of the present invention as defined in the following claims.

1. A method of providing to a user digital programming at a receiver station, comprising the steps of:
storing a plurality of digitally compressed video signals on a digital versatile disk, each signal corresponding to a different video option of a program, wherein the plurality of video signals comprise at least one standard video signal;
receiving the plurality of digitally compressed video signals;
selecting one of the video options;
digitally decompressing the selected video signal corresponding to the selected video option; and
displaying the selected video signal corresponding to the selected video option, wherein visual transition to the selected video signal is seamless.

2. The method of claim 1, wherein the digital versatile disk is located at a central location.

3. The method of claim 1, wherein the digital versatile disk is located at the receiver station.

4. The method of claim 1, wherein the receiver station is a digital television.

5. The method of claim 1, wherein the receiver station comprises a personal computer with a television card.

6. The method of claim 1, wherein the receiver station comprises a digital cable box and a television, operably connected to the digital cable box.

7. The method of claim 1, further comprising the steps of:
indicating to the user the different video options;
receiving from the user a command indicating the selected video option.

8. The method of claim 1, wherein the plurality of video signals further comprise at least one closeup video and at least one slow motion video replay.

9. The method of claim 1, wherein the plurality of video signals comprise at least one replay video.

10. The method of claim 1, further comprising the steps of:
creating a viewer profile;
wherein the selecting step comprises the substep of selecting the video option based at least in part on the viewer profile.

11. The method of claim 1, further comprising the steps of:
obtaining a plurality of graphics segments;
selecting at least one graphic segment;
displaying the selected graphic segments.

12. The method of claim 11, wherein at least one of the graphics segments is stored in the digital versatile disk.

13. The method of claim 1, further comprising the step of receiving a plurality of audio signals.

14. The method of claim 13, wherein each audio signal is associated with one of the video signals.

15. The method of claim 13, wherein at least one of the audio signals is stored in the digital versatile disk.

16. A system of providing to a user digital programming at a receiver station, comprising:
a digital versatile disk, wherein the digital versatile disk stores a plurality of digitally compressed video signals;
a means, operably connected to the digital versatile disk, for receiving a plurality of digitally compressed video signals, each signal corresponding to a different video option of a program, wherein the plurality of video signals comprises at least one standard video signal;
a processor, connected to the receiving means, wherein the processor selects one of the video options;
a digital decompressor, operably connected to the processor, for decompressing the selected video signal corresponding to the selected video option; and
a display screen, operably connected to the digital decompressor, for displaying the selected video signal corresponding to the selected video option, wherein visual transition to the selected video signal is seamless.

17. The system of claim 16, wherein the digital versatile disk is located at a central location.

18. The system of claim 16, wherein the digital versatile disk is located at the receiver station.

19. The system of claim 16, wherein the receiver station is a digital television.

20. The system of claim 16, wherein the receiver station comprises a personal computer with a television card.

21. The system of claim 16, wherein the receiver station comprises a digital cable box and a television, operably connected to the digital cable box.

22. The system of claim 16, further comprising a means for receiving at least one graphics segment.

23. The system of claim 22, wherein the graphics segment is displayed to the user on the display screen.

24. The system of claim 16, wherein the plurality of video signals further comprise at least one closeup video and at least one slow motion video replay.

25. The system of claim 16, wherein the plurality of video signals further comprise at least one replay video.

26. The system of claim 16, further comprising a storage device, wherein a viewer profile is stored in the storage device and the processor selects the video option based at least in part on the viewer profile.

27. The system of claim 16, further comprising a means of receiving a plurality of audio signals.

28. The system of claim 27, wherein each audio signal is associated with one of the video signals.

29. The system of claim 27, wherein the plurality of audio signals are stored in the digital versatile disk.

30. A method for preparing a plurality of digital signals at a central location for seamless switching at subscriber reception sites, comprising the steps of:
receiving a plurality of video signals at the central location;
genlocking the plurality of video signals, wherein genlocking creates time synchronized video signals;
directing the plurality of video signals into one or more video encoders;
inserting splice points into the plurality of video signals;
time synchronizing the plurality of video encoders, thereby ensuring that the splice points inserted in the video occur at a correct frame number;
digitally compressing the plurality of digital video signals in the video encoders, forming a digital program stream, wherein the digital video signals are encoded at a lower bit rate than channel capacity resulting in creation of certain time gaps in each of the video signals;
wherein program switching from one video signal to another video signal at the subscriber reception sites is made seamless through the creation of the time gaps, the time gaps representing switch times thereby allowing time for a seamless switch from one of the video signals to another video signal;
storing the digital program stream on at least one digital versatile disk.

31. The method of claim 29 wherein a plurality of audio signals are associated with the plurality of video signals and further comprising the steps of receiving the plurality of audio signals, encoding the plurality of received audio signals and compressing the plurality of audio signals.

32. The method of claim 29 wherein the encoder receives a plurality of data computer codes and further comprising the step of encoding the received plurality of data computer codes with the plurality of video signals.

33. A digital encoding system for preparing a plurality of digital signals at a central location for seamless switching at subscriber reception sites, comprising:
at least one video genlock device, for receiving the plurality of video signals and creating time synchronized video signals;
at least one video encoder, connected to the video genlock device, for inserting splice points into the plurality of video signals, and encoding and compressing the plurality of video signals to form a digital program stream, wherein the video encoders are time synchronized;
wherein the digital video signals are encoded at a lower bit rate than channel capacity resulting in creation of certain time gaps in each of the video signals, the time gaps representing switch times thereby allowing time for a seamless switch from one of the video signals to another video signal; and
at least one digital versatile disk storage means, operably connected to the video encoder, for storing the digital program stream.

34. The digital encoding system of claim 33 further comprising a transmitter means, operably connected to the digital versatile disk storage means, for transmitting the plurality of digital program streams onto a subscriber distribution network selected from the group consisting of cable television, broadcast television, and direct broadcast satellite.

35. The digital encoding system of claim 33 wherein a plurality of audio signals are associated with the plurality of video signals and the encoder receives the plurality of audio signals and encodes and decompresses the plurality of audio signals.

36. The digital encoding system of claim 33 wherein the encoder receives a plurality of data computer codes and encodes the data computer codes with the plurality of video signals.

37. The digital encoding system of claim 33 wherein at least one of the video signals comprises a regular television program signal.

38. The digital encoding system of claim 33 wherein the at least two of the video signals comprises interactive program signals of an interactive program.

39. The digital encoding system of claim 33 wherein the plurality of video signals comprise one or more advertisements.

40. The digital encoding system of claim 33 wherein at least two of the plurality of video signals comprise different camera angles of the same event.

41. The digital encoding system of claim 33 wherein at least one of the digital video signals contains a close-up view of an event.
